(19) United States
(12) Patent Application Publication
(10) Pub. No.: US 2024/0399181 A1
(43) Pub. Date: Dec. 5, 2024

(54) SELF-SUFFICIENT LOW-COST MITIGATION MODEL TO IMPROVE RESILIENCE IN POWER UTILITY WILDFIRE RESPONSE

(71) Applicant: The Texas A&M University System, College Station, TX (US)

(72) Inventors: Amarachi Tochi Umunnakwe, College Station, TX (US); Katherine Rogers Davis, College Station, TX (US)

(73) Assignee: The Texas A&M University System, College Station, TX (US)

(21) Appl. No.: 18/680,572

(22) Filed: May 31, 2024

Related U.S. Application Data
(60) Provisional application No. 63/469,986, filed on May 31, 2023.

(51) Int. Cl. A62C 3/02; B64D 1/16; G05D 1/656; G05D 105/55; G05D 109/20; G06Q 50/26

(52) U.S. Cl. CPC A62C 3/0228; A62C 3/0271; B64D 1/16; G05D 1/665; G06Q 50/265; G05D 2105/55; G05D 2109/20

(57) ABSTRACT

A method for predictive fire control, comprising identifying a plurality of wildfire risk points on a power grid, calculating a route for an unmanned aerial vehicle (UAV) to intersect with a maximum number of points as a function of a range of the UAV, controlling the UAV to traverse the route, monitoring one or more sensors for an indication of a wildfire event and controlling the UAV to release a fire retardant on the fire.

### RELATED APPLICATIONS

This application claims benefit of and priority to U.S. Provisional Patent Application No. 63/469,986, filed May 31, 2023, which is hereby incorporated by reference for all purposes as if set forth herein in its entirety.

### TECHNICAL FIELD

The present disclosure relates generally to forest management, and more specifically to a self-sufficient low-cost mitigation model to improve resilience in power utility wildfire response.

### BACKGROUND OF THE INVENTION

Wildfires cause substantial damage and loss of life every year, but systems and methods to mitigate the damages that result from wildfires are not well known.

### SUMMARY OF THE INVENTION

A method for predictive fire control is disclosed that includes identifying a plurality of wildfire risk points on a power grid using a processor, calculating a route for an unmanned aerial vehicle (UAV) to intersect with a maximum number of points as a function of a range of the UAV using the processor, controlling the UAV to traverse the route using the processor, monitoring one or more sensors for an indication of a wildfire event using the processor and the UAV, and controlling the UAV to release a fire retardant on the fire using the processor.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for a deep learning based framework for analyzing the expected spatiotemporal impacts of stochastic wildfire threat on the power grid, in accordance with an example embodiment of the present disclosure;

FIG. 2 is a diagram of a system for data pre-processing and integration (solid arrows) and feature extraction and training the predictor (dashed arrows), in accordance with an example embodiment of the present disclosure;

FIG. 3 is a diagram of a Self-Sufficient Low-Cost Power System Wildfire Resilience (SL-PWR) System, in accordance with an example embodiment of the present disclosure;

FIG. 4 is a diagram of a system for a ResNet-18 architecture, in accordance with an example embodiment of the present disclosure;

FIG. 5 is a diagram of a system for implementation of an identity shortcut connection via the residual block to avoid the depreciating performance of having many convolutional layers, in accordance with an example embodiment of the present disclosure;

FIG. 6 is a diagram of a system for calculating real-time wildfire spread and scaling to a grid area when UAV distance to ground level varies by the parameter “a,” in accordance with an example embodiment of the present disclosure;

FIG. 7 is a diagram of a system for restoration estimation for damaged poles, in accordance with an example embodiment of the present disclosure;

FIG. 8 is a diagram of a system for UAV resource optimization, in accordance with an example embodiment of the present disclosure;

FIG. 9 is a diagram of a system for UAV resource optimization, in accordance with an example embodiment of the present disclosure;

FIG. 10 is a diagram 1000 of a UAV trip with destination nodes {D1, D2, D3, D4, D5, D6}, in accordance with an example embodiment of the present disclosure;

FIG. 11 is a diagram showing random search hyper-parameter optimization to ensure that more of the hyper-parameter space is visited while training the CNNs, in accordance with an example embodiment of the present disclosure;

FIG. 12 is a diagram of a UAV monitoring system, in accordance with an example embodiment of the present disclosure; and

FIG. 13 is a diagram of an unmanned aerial vehicle 1300 in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

This application claims benefit of and priority to U.S. Provisional Patent Application No. 63/469,986, filed May 31, 2023, which is hereby incorporated by reference for all purposes as if set forth herein in its entirety.

The electric power grid is a complex and essential infrastructure. In the United States, there are 16 critical infrastructures including food, water, medical care, communications, finance, and more which heavily depend on the electric grid. The goal of the power grid is to maintain reliable provision of electricity to end users. As technologies advance and civilizations expand, the demand for electricity grows and the power grid constantly evolves to meet modern needs by adopting new technologies, architectures, operational and planning approaches, while integrating security and affordability. In hostile environments such as those influenced by malicious attacks and hazards that threaten the grid, the goal of providing reliable power and trustworthy operations is met by improving grid resilience.

Resilience was first introduced as a measure to determine the system's ability to absorb changes to its state and driving variables. Resilience has quickly become paramount in power systems operations and planning, with substantial federal infrastructure investments catering to High Impact Low Frequency (HILF) events like natural disasters and cyber threats. However, since power systems keep evolving, the definition of power system resilience has yet to be consolidated.

The present disclosure improves power system resilience, to facilitate the science and perspective of resilience-oriented risk reduction. Resilience can be characterized by: (a) the magnitude of shock the system can absorb and remain within a given state, (b) the degree to which the system is capable of self-organization, and (c) the degree to which the system can build capacity for learning and adaptation. In power systems, resilience can be defined as the grid's ability to prepare for and adapt to changing operating conditions, as well as withstand and recover rapidly from major disruptions caused by naturally occurring threats or deliberate cyber-physical attacks.

Resilience can be modelled using different phases in which the system lies in the course of HILF events. In a pre-event phase, the system operates at normal conditions, and as the disruptive event strikes, the system absorbs some shock and goes into the alert state. Further degradation sends the system into an emergency state, then to the outage phase which is an abnormal state. In this state, corrective and emergency resources are applied towards critical load restoration, also known as the self-recovery when the emergency resources are pre-integrated into system operations. After prioritized restoration of critical loads, recovery efforts continue with repair and restoration of damaged infrastructure.

Resilience phases can be associated with different capabilities including the withstanding, absorptive, adaptive and restorative capabilities. These capabilities can also be associated with the resilience dimensions namely robustness, redundancy, resourcefulness, and rapidity. Robustness, associated with the withstanding capability, is the ability of the system to withstand disruption up to a given level without loss of functionality. Redundancy is the extent to which components and subsystems can be substituted to satisfy the suffered loss of functionality. It is associated with the absorptive capability at the disruption transition and outage phases. Resourcefulness is the ability of the system to identify system failures, prioritize and mobilize resources when conditions threaten the system, or towards meeting target recovery. It can be assessed between the disruption and restorative transition phases. Rapidity is the ability to meet recovery priorities in a timely manner in order to contain losses and maintain functionality.

A major issue in power system resilience is a lack of standardization. One solution that can be used is an approach based on the Axiomatic Design Process (ADP). The ADP is a logical process towards an objective through a series of domains, including the (1) Service Domain, (2) Functional Domain, (3) Physical Domain, and (4) Process Domain. In the present disclosure, the resilience capabilities are adapted as the power system resilience objectives towards meeting customer needs in the service domain during a HILF event. These objectives are then transformed into functional requirements (FRs) in the Functional Domain, and Design Parameters (DPs) are defined in the Physical Domain to specify the recognized FRs. Hence, for the power system to be considered resilient, it should meet the functional requirements, which can be achieved using the outlined DPs.

Risk is a common term encountered with power system resilience, and had earlier been used interchangeably. However, risk is also a function of threat, which could be adversarial and intentional or otherwise, that leverages vulnerability. Since threat occurrence can be assumed certain and beyond the control of the system operator, the operator can take actions that minimize adversary impact or minimize system vulnerabilities to threats, in order to reduce risk. These actions function to strengthen the system and herein tie back to system resilience, as shown the following relationship (1.1):

$$Risk = Likelihood \times Impact$$

$$Likelihood = Threat \times Vulnerability$$

$$Threat = Capability \times Intent$$

One goal of risk assessment is to aid situational awareness, which is defined as the perception of the elements in an environment within a volume of time and space, the comprehension of their meaning and a projection of their status in the near future. Hence, situational awareness implies spatio-temporal observation and forecast/prediction/estimation of a system's state. In power systems, this can be near real-time as in power systems operations or longer, towards planning. Hence, situational awareness involves the recognition of system elements that inform the system state and enable effective power system response. For instance, perception of system states could include: generation, transmission, distribution data, schedules for load and market, device (e.g., switch, breaker, bus, relay) status, environmental and atmospheric conditions.

Therefore, the comprehension of these perceptions could include: analyzing and understanding the resulting deviation between the expected (estimated) vs. current state of the system, system capabilities and vulnerabilities, possible actions and operator responses. The implication is that within this comprehension of the perceived state lies risk assessment. The projection of this understanding is the inference of future system state and the time criticality of operator response. These characteristics of SA can be seen as a cycle in power systems where projecting the future system states would lead to further perception of that future “projected” state. Similarly, to aid decision making in risk situations, SA models like the Observe, Orient, Decide, Act (OODA) loop can be used. However, for resilience, the SAAL (Sensing, Anticipating, Adapting, and Learning) model can be used, which expands on the OODA to emphasize the nuance that resilience additionally requires the ability to anticipate and learn.

Power System State Estimation (PSSE) is a technique that informs situational awareness by collecting data from the bulk power grid, in a process to estimate the electrical state of a network, by eliminating inaccuracies and errors from measurement data, and analyzing the data to minimize risk. The PSSE's objective is to estimate system state x by minimizing the following function:

$$\hat{x} = {{min}_{x} ( z - h ( x ) )}^{T} {R}^{- 1} ( z - h ( x ) ) , \qquad ( 1.2 )$$

where x is the state vector which will have the form:

$${x}^{T} = [ {θ}_{2} , {θ}_{3} , … , {θ}_{N} , {V}_{1} , {V}_{2} , … , {V}_{N} . ]$$

when bus 1 is the slack bus, z represents measurements/observations from field devices consisting of active and reactive power injections at buses (Pi,Qi) and active and reactive power flows on branches (Pij, Qij). Pi and Qi at bus i is given as:

$$\begin{matrix}{P}_{i} = {\sum }_{j ∈ {Ω}_{i}} {V}_{i} {V}_{j} ( {G}_{ij} cos {θ}_{ij} + {B}_{ij} sin {θ}_{ij} ) = {P}_{{G}_{i}} - {P}_{{L}_{i}} \\ {Q}_{i} = {\sum }_{j ∈ {Ω}_{i}} {V}_{i} {V}_{j} ( {G}_{ij} sin {θ}_{ij} + {B}_{ij} cos {θ}_{ij} ) = {Q}_{{G}_{i}} - {Q}_{{L}_{i}}\end{matrix} \qquad ( 1.3 )$$

The Pᵢⱼ and Qᵢⱼ from bus i to bus j is:

$$\begin{matrix}{P}_{ij} = {V}_{i}^{2} ( {g}_{xi} + {g}_{ij} ) - {V}_{i} {V}_{j} ( {g}_{ij} cos {θ}_{ij} + {b}_{ij} sin {θ}_{ij} ) \\ {Q}_{ij} = {V}_{i}^{2} ( {b}_{si} + {b}_{ij} ) - {V}_{i} {V}_{j} ( {g}_{ij} sin {θ}_{ij} - {b}_{ij} cos {θ}_{ij} ) .\end{matrix} \qquad ( 1.4 )$$

Therefore, if the estimated state of the system derived from system status measurements deviates from expectations, the power system utilizes bad data detection (BDD) to identify bad (erroneous) measurements, which could have sourced from power grid threats.

A crucial type of threat to characterize and defend in the critical power grid is the type of threat that presents operational impact and threat to reliability. Specifically, for state estimation attacks, this could appear as false data that drives the deviation of grid operating points, as much as possible, from normal. The power grid is vulnerable to threats from a myriad of sources. The vulnerability of the grid can arise from aging infrastructure, which when combined with increasing power demand, makes the grid susceptible to faults and failures e.g., cascading failures, as has been witnessed during periods of harsh weather. Hence, modernizing the grid has become a high priority for the U.S.

Modernization, however, incorporates the integration of a continually growing network of hardware and software which redefine and increase the attack surface, favoring grid adversaries. This creates a new reality which is that most grid components operate in internet-accessible digital environments. Operation in digital environments has shifted operational technology towards increasingly allowing external connections and remote access to business networks, which could lead to threat actors accessing the systems to disrupt operations. For instance, the distribution grid operation using Internet of Things (IoT) could be compromised by adversaries where devices can be manipulated and used to launch coordinated demand-side attacks. Furthermore, the modern grid integrates widely available devices, which use traditional networking protocols for controlling grid components. This can further increase the threat surface for the grid, e.g., Phasor Measurement Units (PMUs) which are dependent on GPS timing to monitor grid state towards control of generation, transmission, and distribution functions, can be attacked and desynchronized.

Reported cyber events have increased, and suspicious activity with unidentified causes which can be physical or cyber-attacks, have increased as well. In April 2021, the Colonial pipeline attacks affected roughly 45% of the East Coast's supply of energy resources. The purpose of a cyber-attack on a SCADA system could range from a hacker trying to access and scale through system defenses, to an adversary possibly generating “false” information to the SCADA system for espionage. The present disclosure focuses on risk reduction to cyber threats of adversary intrusion and false data injection attacks.

Threats to the grid can also be physical. These can be due to vandalism or attacks from local nation state adversaries to power plants and substations. These threats can be addressed using a risk-based approach. Physical threats can also include existential threats from weather-based events such as hurricanes, tornados, wildfires, and floods, that have devastating impacts on the power grid. The top threats that have affected the U.S. grid have generally increased over the past couple of years. Severe weather can be the most frequent and also the most impactful. Extreme weather conditions are the most common cause of energy disruptions in the U.S. where major power outages from weather related events in the U.S. increased by approximately 67% since 2000. In June 2021, unusual high summer temperatures caused record-high demands to the Texas grid putting the grid under enormous pressure. On a similar note, February 2021 saw extreme cold weather conditions lead to a winter storm which destabilized the Texas power grid, causing millions of people to lose power for multiple days in the freezing temperatures thus leading to 702 deaths. Wildfire threats also cause increasing widespread impact to the power grid. The impact ranges from increasing acres burnt, to loss of lives and property, bankruptcy of utilities, law suits against utilities, lost opportunity costs, and significant costs on the federal, state, local, and territory levels.

The modernization and hence, digitization of utility networks which has also expanded to commercial services and external-facing websites, such as corporate and vendor websites, exposes the power network to threats of adversary intrusion from these internet-facing hosts. A major problem in SCADA is the complete access often granted to third party organizations, such as vendors, to internal systems. Organizations may grant third-party vendors either complete access with no restrictions or high-level access with very few restrictions, to their SCADA/ICS systems. This level of trust and access granted to these third party organizations, business partners, and government organizations, can expose the system to threats of adversary intrusion from these external-facing access points. Hence, from a risk-based perspective, it is highly crucial for critical systems to analyze and access their risk to adversary intrusion that can arise from these sources

In the cyber space, risk assessment to adversarial threats can be aided by information and frameworks provided by several organizations and agencies. Such agencies include the National Institute of Standards and Technology (NIST) which provides voluntary guides and practices aimed at cultivating trust in Information Technology (IT), and the transition between IT and Operational Technology (OT). The Common Vulnerability Scoring System (CVSS) scores for the Common Vulnerabilities and Exposures (CVE) obtained from the NVD, which is part of NISTS's Security Content Automation Protocol, is formally adopted as an international standard for scoring vulnerabilities. For instance, an attack source vertex may leverage knowledge of required username and password to remotely access another sink vertex with hard-coded SSH credentials by exploiting vulnerability CVE-xxxx-xxxx with a score computed using the impact and exploitability subscores. The impact subscore can be calculated based on the impact of Confidentiality, Integrity, and Availability, where Confidentiality is the limitation of information access to authorized users and preventing disclosure to unauthorized users, Integrity is the veracity of information, while Availability is the accessibility of information resources or node functionality. The exploitability subscore is calculated based on the attack vector, the attack complexity, the privilege required to execute such attack, and the user interaction as well. Hence, this knowledge base is useful for risk assessment to known vulnerabilities giving the ease of exploitation of such vulnerability and its impact to the system as discussed.

When an adversary completes a successful intrusion, there are several threats that the adversary poses to the power system operation. To impact power systems operation, the adversary aims to move the system state as much as possible from normal. To achieve this, the adversary can compromise the communication between sensory/measurement and control devices to inject false information. The false information could be false data from the field measurement devices/sensors, or false command to the control devices, and is referred to as False Data Injection Attacks (FDIA). FDIA will then misinform the system operator, and lead to operational actions which can be detrimental to the power grid.

The objective of the adversary in an FDIA is to create a new measurement vector of sensor readings from field devices in a stealth way such that undetectable errors, that can bypass the BDD, are introduced into the calculations of variables and values used in power system state estimation. Mathematically, the FDIA can be represented as in equation (1.5).

$$\begin{matrix}{z}_{o} = h ( \hat{x} ) , \\ {z}_{a} = a + {z}_{o} = h ( {x}^{⋁} ) ,\end{matrix} \qquad ( 1.5 )$$

where:
\hat{x} and x̆ denote the estimated (original) state vector and false data injected state vector
zₒ and zₐ stand for the original and attacked measurements, respectively
a represents the attack vector which can be any of the following: 1.) Deletion of data from zₒ, 2.) Change of data in zₒ, 3.) Addition of fake data to zₒ.

Wildfires are natural or power equipment-caused HILF events that threaten power grid resilience. This realization not only leads to increasing severe economic impact via direct/indirect costs from firefighting, infrastructure damage (critical infrastructure such as healthcare, water, gas, power generation dams), lost opportunity costs from public safety power shutoffs, business interruption costs etc., but as well leads to severe social impact including loss of lives and property, manslaughter lawsuits from customers against utilities, and lack of trust from customers to service area utilities. The California Department of Forestry and Fire Protection estimates the dollar cost of wildfires to property owners, taxpayers, and critical utilities, increased by up to 300% over the past decade. In the United States, the annualized economic burden from wildfires is estimated up to $347.8 billion. In 2018 alone, California's wildfires cost the US economy about $148.5 billion which is approximately 1% of the entire United States annual GDP.

The resilience of power systems to wildfires has been studied, but in the present disclosure, a wildfire resilience trapezoid was used to comprehensively capture the different phases in which the power system lies before, during, and after wildfire threats/events. It also defines power system preventive, corrective, restorative, and adaptive actions utilized in each of these phases comprising the planning phase in which stakeholder take decisions on the structural attributes, such as grid hardening actions, that boost robustness of the grid and hence improve wildfire resilience. The wildfire analysis phase comprises of the preventive actions, such as vegetation management, that are preparatory and taken towards mitigating wildfire threats.

When a wildfire threat is active, certain more stringent measures, e.g., public safety power shutoff, are taken in order to ensure that power equipment do not serve as ignition sources, nor aid to exacerbate the potential fire. When the threat of wildfires is realized, the stakeholders make further decisions towards firefighting which could include “Let-burn” strategies where power systems let a wildfire burn and rebuild infrastructure as opposed to more expensive firefighting efforts. From when the wildfire threat is active to when the wildfire is suppressed is referred to as the wildfire progression phase. After suppression, post wildfire restoration and adaptation towards better system planning for improved wildfire resilience, follows.

The present disclosure provides important technological improvements to systems and methods, to reduce the risk that accrues to the critical cyber-physical power system resulting from top cyber and physical threats. On the cyber side, the present disclosure follows the adversary process as a complete loop from adversary intrusion into the power system network to the realization of the adversary objective of injecting false data to deviate the system from normal operation. Hence, the present disclosure reduces the system risk from adversary intrusion to attack realization. Furthermore, the present disclosure provides a novel method for power system controls to automate the risk assessment process through the design and development of an emulation tool that automatically rebuilds the utility network in a virtual environment, allowing for several use cases that improve system resilience. On the physical threats, the work focuses on the high impact threat of wildfires which have plagued critical infrastructure on the territory, local, state, and federal levels. It provides a spatiotemporal data-driven technique in modeling wildfire threats, better suited for risk reduction for the bulk power grid. Furthermore, the present disclosure provides an important tool that comprehensively meets resilience needs in the (pre-event, event progression, and post event) pipeline of critical infrastructure response to the severe threat of wildfires.

A cyber-physical component ranking for risk sensitivity analysis using “betweenness” centrality is provided by the present disclosure. Given the threat of adversary intrusion, a framework for critical component ranking in power system risk analysis is provided, which can be used to generate graphs of potential attack paths and traverse generated attack graphs to rank components according to their importance in reducing adversary impact on the power system. The services and security cost of communications between power system components, and the likelihood of component exploitation as an adversary medium to the target relays is considered.

Assuming that an adversary has completed intrusion and thus poses a false data injection threat, a Graph Neural Network (GNN) based FDIA detection model for smart power grids can be used to automatically represent the underlying graph topology and spatially correlate the smart grid measurement data to detect and hence, mitigate the risk associated with stealth cyber-attacks, by raising alarms to the power system operator. Hence, the proposed GNN-based detection model is scalable and can detects FDIAs in real-time by efficiently combining model-driven and data-driven approaches that incorporate the inherent physical connections of modern AC power grids and exploiting the spatial correlations of the grid measurements.

The present disclosure also provides a tool for recreating power system communication networks automatically. The daily operations of critical infrastructures have long relied on computer networks, and often incorporate legacy devices and protocols with limited security functions. To study the risk associated with these systems, their architectures have to be replicated in a safe test environment.

The disclosed tool (OpenConduit) automatically rebuilds and realistically replicates electric power system networks in an emulation environment in order to accurately and scalably automate risk studies. The objective targets the creation of the critical infrastructure's digital twin that enable use cases which improve resilience and enable risk reduction. Potential use cases enabling the tool's utility are also presented.

The resilience-oriented risk reduction to physical wildfire threats is also provided. A two-stage framework is used for assessing power system-wildfire risk using a data-driven model to predict wildfires which threaten portions of the transmission and distribution grid. The first stage of the framework estimates the spatiotemporal probability of potential wildfire ignition and propagation using a deep neural network (DNN) in combination with the wildfire physical spread model. The second stage assesses the wildfire risk in the power grid operation in terms of potential loss of load by de-energization, through combining geospatial information system data of the power grid topology and the stochastic spatiotemporal wildfire model developed in the first stage.

A coordinated risk management and comprehensive approach to improve resilience and economics in power utilities' wildfire response before, during, and after wildfires is also provided. The self-sufficient low-cost wildfire mitigation model (SL-PWR) detects and localizes wildfire occurrence, spread, and other wildfire-related using optimized artificial intelligence techniques. The SL-PWR's comprehensive nature informs power system resilience at the different phases of the resilience trapezoid, utilizing spatio-temporal wildfire potential probability maps, equipment layer information (e.g., equipment aging), vegetation layer information (e.g., vegetation-fuel correlation), and optimized UAV monitoring trees to obtain input images for training. The SL-PWR wildfire mitigation tool is the first of its kind that achieves effective response strategies, and rapidity via automation, in the complete pipeline from pre-wildfire, to wildfire progression, to restoration/recovery and adaptation. Results show that SL-PWR improves situational awareness and resilience during extreme threats to several critical infrastructure, primarily power grids.

A detailed analysis of the economic viability, diverse functionality and utility of the SL-PWR and it's deployment advantages with respect to utility methods and existing wildfire mitigation tools is also presented. A return on investment (ROI) of the SL-PWR is used as opposed to conventional utility methods based on some economic benefits provided by the SL-PWR amongst many such as social benefits, environmental sustainability, operational/technical benefits, and so forth.

A resilience oriented risk reduction for the critical cyber-physical power system to the physical threat of wildfires is provided. The increasing magnitude and frequency of power outages induced or motivated by wildfires affects the operation of critical services and leads to lost opportunity costs. In response to wildfire threats, utilities have significantly invested on wildfire monitoring systems and analytical tools, which generally rely on observations from remote automated weather stations to evaluate current weather conditions that are disseminated and retrieved from many sources such as Synoptic's Mesonet API. These data are then used to estimate and strategize for optimal operation in the face of wildfire threats, but with room for improvements.

Studies on wildfire prediction and estimation have mainly focused on numerical quantification and fire scale, often using techniques such as regression, in an effort to aid mitigation. Wildfire variables can be used to predict spatial patterns of ignition, producing national-level ignition risk maps. To aid pre-wildfire planning, fire danger mapping system based on numerical weather prediction and derived moisture content of live fuels can be used. Historical data for vegetation, climate and locational features have been utilized to predict the risk of wildfire ignition. However, these region-specific wildfire models are simply aggregated over space or time with approximated/linear and spatially constant effects. Hence, their accuracy can be affected by the limited integration of the non-linear influence of variables, and similarly, do not fully utilize recent wildfire monitoring investments of grid utilities.

Wildfire risk prediction has also been done where model performance using machine learning approaches have been evaluated. Artificial intelligence techniques have also been effective for wildfire analysis and outperform conventional statistical methods. Additionally, interactive maps have been garnering literary and industry application to supply information on wildfires in real-time. For instance, a real-time fire prediction system can be used for visualizing wildfire risk at specific locations based on a machine learning model. Although these methods prove effective, they generally have not been designed to integrate with the power grid operations. The effect of this on the power system side is the assumption of already progressing wildfires, while geographical uncertainties of spatiotemporal variables are often assumed and not investigated. For instance, energy dispatch is optimized assuming an already progressing wildfire. The same progressing wildfire assumption is applied to dynamically change thermal ratings of power lines and to optimize resource preparation.

Conventionally, electric power utilities have often performed fundamental analysis to indicate wildfire threat alert on coarse resolutions of spatial areas while not utilizing the richness of historical data, evident in indices such as the Fire Potential Index. This index, for instance, utilizes a linear summation of present weather variables and fuels to provide threat levels (extreme, elevated, normal) for predefined regional-scale threat areas. This may arguably lead to over-estimation of risk, over-allocation of operational resources, and consequently “conservative” risk analysis for utilities.

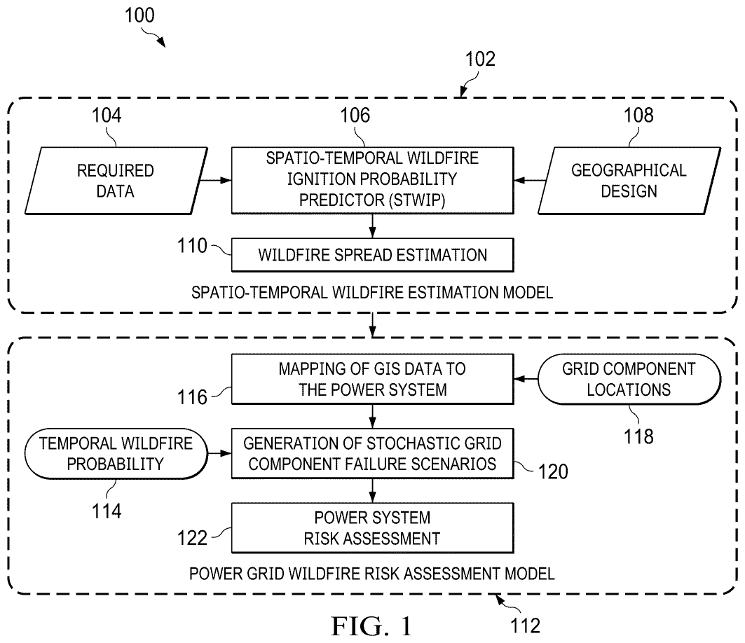

FIG. 1 is a diagram of a system 100 for a deep learning based framework for analyzing the expected spatiotemporal impacts of stochastic wildfire threat on the power grid, in accordance with an example embodiment of the present disclosure. System 100 includes spatiotemporal wildfire estimation system 102, required data system 104, spatiotemporal wildfire ignition probability predictor system 106, geographical design system 108, wildfire spread estimation system 110, power grid wildfire risk assessment model system 112, temporal wildfire probability system 114, mapping of GIS data to the power system 116, grid component locations system 118, generation of stochastic grid component failure scenarios system 120 and power system risk assessment system 122, each of which can be implemented in hardware or a suitable combination of hardware and software.

Spatiotemporal wildfire estimation system 102 can be implemented as one or more lines of code that are stored in memory and loaded into a working memory of a processor to configure the logic devices of the processor to generate risk data for spatiotemporal wildfire estimation. In one example embodiment, spatiotemporal wildfire estimation system 102 can receive and process data as discussed and described further herein to generate wildfire risk estimates, which can be used to schedule wildfire risk reduction design and maintenance. In one example embodiment, tree and shrub trimming activities can be scheduled for areas that have the highest risk of wildfire in advance of areas that have a lower risk, power line equipment repair and maintenance activities can be scheduled for areas that have the highest risk of wildfire in advance of areas that have a lower risk, and other suitable scheduling can be performed by spatiotemporal wildfire estimation system 102 or other suitable systems or processes.

Required data system 104 can be implemented as one or more lines of code that are stored in memory and loaded into a working memory of a processor to configure the logic devices of the processor to receive and process data for spatiotemporal wildfire ignition probability analysis. In one example embodiment, required data system 104 can interface with external systems such as databases or data generation systems to receive and format the data for analysis, as discussed and described further herein.

Spatiotemporal wildfire ignition probability predictor system 106 can be implemented as one or more lines of code that are stored in memory and loaded into a working memory of a processor to configure the logic devices of the processor to process wildfire data and geographical data to generate wildfire probability prediction data. In one example embodiment, spatiotemporal wildfire ignition probability predictor system 106 can use artificial intelligence processing to generate wildfire ignition probability data as discussed and described further herein.

Geographical design system 108 can be implemented as one or more lines of code that are stored in memory and loaded into a working memory of a processor to configure the logic devices of the processor to receive and process geographical design data for spatiotemporal wildfire ignition probability analysis. In one example embodiment, geographical design system 108 can interface with external systems such as databases or data generation systems to receive and format the data for analysis, as discussed and described further herein.

Wildfire spread estimation system 110 can be implemented as one or more lines of code that are stored in memory and loaded into a working memory of a processor to configure the logic devices of the processor to receive and process wildfire ignition probability data, geographical data and other suitable data to generate wildfire spread estimate data. In one example embodiment, wildfire spread estimation system 110 can interface with external systems such as databases or data generation systems to receive and format the data for analysis, as discussed and described further herein.

Power grid wildfire risk assessment model system 112 can be implemented as one or more lines of code that are stored in memory and loaded into a working memory of a processor to configure the logic devices of the processor to receive and process wildfire ignition probability data, geographical data and other suitable data to generate wildfire risk assessment data. In one example embodiment, power grid wildfire risk assessment model system 112 can interface with external systems such as databases or data generation systems to receive and format the data for analysis, as discussed and described further herein.

Temporal wildfire probability system 114 can be implemented as one or more lines of code that are stored in memory and loaded into a working memory of a processor to configure the logic devices of the processor to receive and process temporal data, wildfire probability data, geographical data and other suitable data to generate temporal wildfire probability data. In one example embodiment, temporal wildfire probability system 114 can interface with external systems such as databases or data generation systems to receive and format the data for analysis, as discussed and described further herein.

Mapping of GIS data to the power system 116 can be implemented as one or more lines of code that are stored in memory and loaded into a working memory of a processor to configure the logic devices of the processor to receive and process geographic information system data and to map it to the power system. In one example embodiment, mapping of GIS data to power system 116 can interface with external systems such as databases or data generation systems to receive and format the data for analysis, as discussed and described further herein.

Grid component locations system 118 can be implemented as one or more lines of code that are stored in memory and loaded into a working memory of a processor to configure the logic devices of the processor to receive and process power grid equipment data, geographical data and other suitable data to generate grid components location data. In one example embodiment, grid component locations system 118 can interface with external systems such as databases or data generation systems to receive and format the data for analysis, as discussed and described further herein.

Generation of stochastic grid component failure scenarios system 120 can be implemented as one or more lines of code that are stored in memory and loaded into a working memory of a processor to configure the logic devices of the processor to receive and process mapped power system data, temporal wildfire probability data and other suitable data to generate stochastic grid component failure data. In one example embodiment, generation of stochastic grid component failure scenarios system 120 can interface with external systems such as databases or data generation systems to receive and format the data for analysis, as discussed and described further herein.

Power system risk assessment system 122 can be implemented as one or more lines of code that are stored in memory and loaded into a working memory of a processor to configure the logic devices of the processor to receive and process stochastic grid component failure data, geographical data and other suitable data to generate power system risk assessment data. In one example embodiment, power system risk assessment system 122 can interface with external systems such as databases or data generation systems to receive and format the data for analysis, as discussed and described further herein.

System 100 integrates a detailed spatiotemporal wildfire analysis model to evaluate system risk. The model incorporates information from required databases 104 towards potential wildfire ignition maps, as the spatiotemporal wildfire “readiness” of a location does not necessarily imply an ignition until a fire source is applied. Therefore, a model is proposed to estimate the spatiotemporal probability of a potential wildfire ignition which can be applied to power transmission and distribution systems. The advantage in modeling potential ignitions pre-wildfire is to prepare for critical scenarios and proceed with optimal strategies to better mitigate risks arising from extreme wildfire events, thereby reducing the propensity of outages and power shutoff to customers. As wildfires can be caused by power equipment failure or by exogenous causes (human, natural events), the applications of the estimation result are twofold. First, it provides spatiotemporal risk for proactive de-energization against potential power system failure-induced wildfire. Second, it generates a spatiotemporal spreading model for optimal grid operations against potential exogenous wildfires. In summary, the contributions of the present disclosure are as follows:
a comprehensive spatiotemporal wildfire risk analysis framework using a data-driven deep learning approach that efficiently incorporates publicly-available historical data for estimating wildfire ignition risk and its impact on power grid is provided
novel quantitative risk metrics that capture potential effects of fuel, vegetation, and wind speed, on wildfire propagation are provided, while the weighted impacts of wildfire predictive variables are identified to aid utility operations and stakeholder strategy
the disclosure provides information to utilities towards optimizing grid operation, i.e., proactive de-energization to prevent endogenous power system failure induced wildfire and the response strategy e.g., “let-burn”, against exogenous wildfire threats.

Wildfires are influenced by a number spatial and temporal factors that can be unique in different geographical locations which can lead to inaccuracies in pre-specified mathematical models. Hence, the objective of the proposed framework is to drive operational strategy with data-driven situational awareness to wildfire. As shown in FIG. 1, the framework consists of two sequential stages. First, the spatiotemporal wildfire estimation system 102 predicts the probability of potential wildfire ignition, utilizing the spatiotemporal wildfire ignition probability predictor model (STWIP) 106, and estimates potential wildfire spread using wildfire spread estimation system 110, producing important parameters such as ignition probability maps and the rate of spread of potential ignitions to critical power components. These parameters are then passed to the power grid wildfire risk assessment model system 112, which aims to optimize power system operations and risk assessment such that outage cost is minimized. The risk assessment model optimizes power system operations by GIS-enabled mapping of these parameters to the power network and generating wildfire threat scenarios. Part of the risk assessment model also includes proposed power system-wildfire metrics that enable optimal operational strategies such as choosing mitigation vs. restoration (“let-burn”).

The geographical design system 108 of the disclosure can include a spatial location that is a point i with geospatial coordinate i.loc defined by a latitude and longitude (lat,lon) at any location in a grid cell. The grid cells can be 3 km×3 km polygons or other suitable shapes and sizes that have uniform past spatiotemporal wildfire characteristics and a centroid. Each grid centroid also has geospatial coordinates gc.loc. For instance, the past spatiotemporal characteristics of a historical sample ignition that occurred in i can be obtained by its association with gc.loc of the grid cell g∈G in which it is situated, since the centroid can be processed to bear the characteristics of g. Each grid can have a set of historical wildfire ignition events with geospatial coordinates i.loc. These historical events, which form sample points in the training data, can have a set of variables, x=[x1, x2, . . . , xD], obtained for their unique i.loc and dates of ignition. Here, D denotes the dimensionality. These wildfire-informative variables are referred to as Wildfire Predictor Variables (WPVs) and can be sourced from weather stations geographically situated at locations of interest or other suitable sources. Their interactions and correlation can be used for wildfire prediction. They can vary spatially and/or temporally, can be indicative of wildfire occurrence, and can be called explanatory variables.

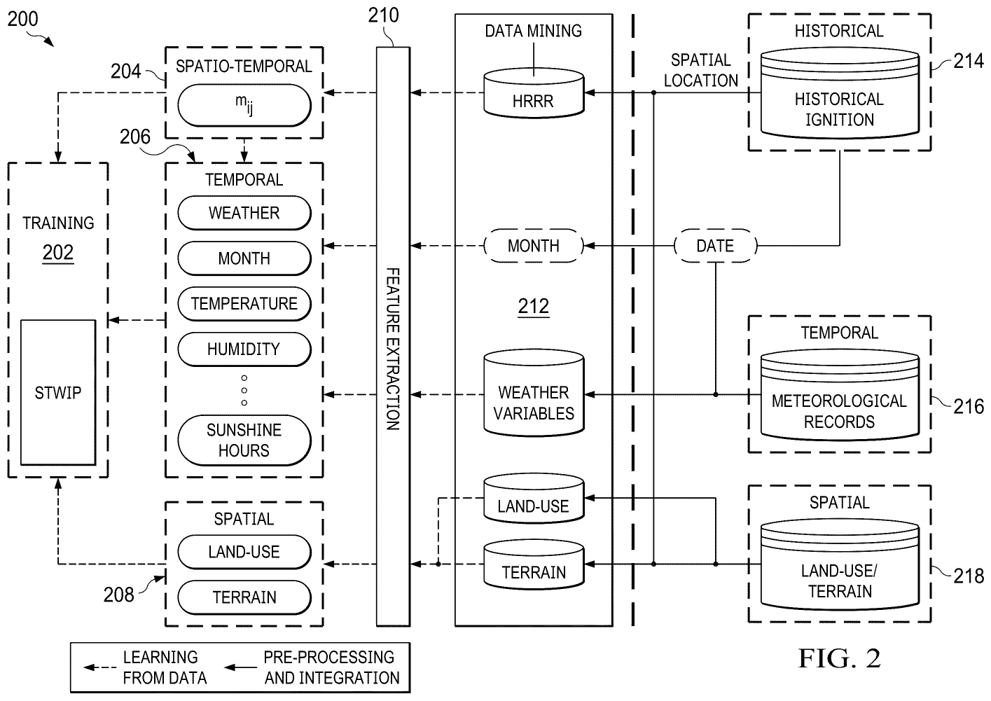

FIG. 2 is a diagram of a system 200 for data pre-processing and integration (solid arrows) and feature extraction and training the predictor (dashed arrows), in accordance with an example embodiment of the present disclosure. System 200 can include STWIP training system 202, spatiotemporal data system 204, temporal data system 206, spatial data system 208, feature extraction system 210, data mining system 212, historical ignition data system 214, temporal meteorological records system 216 and spatial land use/terrain system 218, each of which can be implemented in hardware or a suitable combination of hardware and software.

STWIP training system 202 can be implemented as one or more lines of code that are stored in memory and loaded into a working memory of a processor to configure the logic devices of the processor to train a spatiotemporal wildfire ignition predictor system using spatiotemporal data, spatial data, temporal data and other suitable data. In one example embodiment, STWIP training system 202 can use artificial intelligence processing to generate spatiotemporal wildfire ignition predictor data as discussed and described further herein.

Spatiotemporal data system 204 can be implemented as one or more lines of code that are stored in memory and loaded into a working memory of a processor to configure the logic devices of the processor to process spatiotemporal data to support spatiotemporal wildfire ignition prediction. In one example embodiment, spatiotemporal data system 204 can use one or more external databases and feature extraction data as discussed and described further herein.

Temporal data system 206 can be implemented as one or more lines of code that are stored in memory and loaded into a working memory of a processor to configure the logic devices of the processor to process temporal data to support spatiotemporal wildfire ignition prediction. In one example embodiment, temporal data system 206 can use one or more external databases and feature extraction data as discussed and described further herein.

Spatial data system 208 can be implemented as one or more lines of code that are stored in memory and loaded into a working memory of a processor to configure the logic devices of the processor to process spatial data to support spatiotemporal wildfire ignition prediction. In one example embodiment, spatial data system 208 can use one or more external databases and feature extraction data as discussed and described further herein.

Feature extraction system 210 can be implemented as one or more lines of code that are stored in memory and loaded into a working memory of a processor to configure the logic devices of the processor to extract feature data to support spatiotemporal wildfire ignition prediction. In one example embodiment, feature extraction system 210 can process National Oceanic and Atmospheric Administration's High Resolution Rapid Refresh (HRRR) data, temporal data, weather variable data, land use data, terrain data and other suitable data, as discussed and described further herein to extract feature data of interest for spatiotemporal data system 204, temporal data system 206, spatial data system 208 or other suitable systems or components.

Data mining system 212 can be implemented as one or more lines of code that are stored in memory and loaded into a working memory of a processor to configure the logic devices of the processor to mine data to support spatiotemporal wildfire ignition prediction. In one example embodiment, data mining system 212 can mine HRRR data, temporal data, weather variable data, land use data, terrain data and other suitable data, as discussed and described further herein to extract data of interest for feature extraction system 210 or other suitable systems or components.

Historical ignition data system 214 can be implemented as one or more lines of code that are stored in memory and loaded into a working memory of a processor to configure the logic devices of the processor to generate historical ignition data to support spatiotemporal wildfire ignition prediction, as disclosed and discussed herein.

Temporal meteorological records system 216 can be implemented as one or more lines of code that are stored in memory and loaded into a working memory of a processor to configure the logic devices of the processor to generate temporal meteorological data to support spatiotemporal wildfire ignition prediction.

Spatial land use/terrain system 218 can be implemented as one or more lines of code that are stored in memory and loaded into a working memory of a processor to configure the logic devices of the processor to generate spatial land use/terrain data to support spatiotemporal wildfire ignition prediction, as disclosed and discussed herein.

The grid centroids are used together with spatial data e.g., land-use and terrain data, from databases such as HRRR data or other suitable data. The temporal probabilities, πj of wildfire ignition, can also be calculated in this stage from the US Geological Survey historical ignition data or other suitable data and can be used as a feature to improve estimation. The assumption of a same climate period is enabled by the similarity in the data distribution over the historical period of analysis. A scraper such as the Python scraper can be coded to request and clean meteorological data for unique spatial locations on days of interest. Days of interest can be selected as a function of associated applications, such as meteorological variables on historical ignition and non-ignition days that are duly processed for training/validation of the predictor while forecasted meteorological variables are requested for days that wildfire potential is to be predicted.

The next phase is data integration, which can proceed on two levels. The first is spatial integration, where i.loc of historical ignitions are associated to gc.loc to obtain the past ignition characteristics of g. Spatial locations in the training data can thus inherit wildfire attributes of the grid cell in which they are located. The second occurs after feature extraction during integration, such as into python's pandas data frames, in preparation for training. The data frame can be a two dimensional data structure with columns of multivariate data. The month in which the training ignition sample occurs can be incorporated as a feature to account for temporal relation of features, and can also be critical to the utilization of only one fundamental deep network.

Past spatiotemporal ignition can be used to capture sequential changes in characteristics of spatial wildfire ignition over time and to allow the predictor to use one fundamental deep network. It can be calculated from the historical wildfire database and can be the initial (historical) ignition probability of a spatial location in the same climate period. The past wildfire ignition probability mg,j of a grid cell g in period j of a comprehensive year can be computed. Since this attribute is inherited by all i in grid cell g, this attribute can be referred to as mi,j. If the climate pattern of the multiple-year-dataset is assumed constant, the conditional probability of an ignition occurring in grid cell i given the study area, is used to calculate mi, given that grid cells are a subset of the studied geographical area as in (5.1):

$${m}_{i , j} \approx \frac{{n}_{g , j}}{N} , \qquad ( 5.1 )$$

where n_{g, j} is the total number of wildfires occurred in cell g in period j, and N is the total number of wildfires that occurred in the multiple year period. Assuming constant climate, a multi-year period (e.g., 1996-2016) can be modeled as a comprehensive year. As mentioned earlier, in order to enhance the computation of mi,j considering the scarcity of historical ignitions in some grid cells, the Monte Carlo population technique can be employed in pre-processing the original dataset to further populate grid cells.

Wildfire occurrence is influenced by non-linear and complex meteorological features which are temporally related. Temporal meteorological input includes temperature, rain, humidity, sunshine hours. The choice of these features an be informed by indices such as the Angstrom, Nesterov, and Canadian Forest Fire Weather Index as well as the US Fire Danger Rating System.

Spatial or static features characterize spatial locations for climate periods and are influential to wildfire occurrence. Spatial data of land-use and terrain can be obtained from sources such as the HRRR model which have standard grid points that can serve as grid centroids and enable division of the studied geographical area into grid cells with the same spatial and spatiotemporal features. Historical ignition events that fall within a grid cell are used to obtain mi,j of the respective cells which are in turn inherited by the sample points i within g, during training.

In addition, the past ignition probability and ignition month are also included as spatiotemporal and temporal features respectively.

Training samples are based on historical ignition/non-ignition days, but there may not be much pre-existing data for wildfire analysis. The dates (dd/mm/yy) and corresponding i.loc can be extracted from the historical ignition database and utilized to automatically request training sample variables. Once the features are extracted from obtained variables, this training sample point is assigned with a classification label 1, meaning the historical status of ignition was active for the sample. Next, the feature data are requested for the same i.loc and another (dd/mm/yy) prior to the active ignition date, when no wildfire ignitions were reported to have occurred. This data can be labelled a 0, meaning that the historical status of ignition was inactive for the sample. In particular, the ignition label for a training sample can be defined as:

$$Ign = \{ \begin{matrix}1 , & if & {ign}_{( j )} recorded \\ 0 , & if & {ign}_{( j - n )} ¬ recorded\end{matrix} \qquad ( 5.2 )$$

where lgn is the historical wildfire ignition status in day j, and n=[1, 2, . . . , 30] depending on any day in the given month and year where an ignition was not recorded. This process constitutes the data frame for training the STWIP. For the 0-labelled samples, dates prior to ignition (1-labelled sample) of an i.loc, are chosen since historical ignition could have significantly tampered with temperature, fuel and vegetation, rendering later dates deceptive for use as 0-labelled training samples. It is worth noting that although true absence points are assumed, these 0-labelled samples are pseudo-absence points since it is unknown if ignition could not occur (there was no potential for ignition) or simply did not occur (there was no source of ignition) in that historical date and i.lOC.

A spatiotemporal wildfire estimation model can be constructed as follows. After data construction, the data frame is fed into STWIP as input data following some transformations discussed herein. The input data is cleaned and missing values are provided, such as with an average of their nearest neighbors. A major part of training data processing includes rescaling the features to have the properties of a standard normal distribution (μ=0, σ=1). The need for rescaling arises as features are multivariate with different units. Also, since feature magnitudes in instance xi play a role in the updates applied to the weights during gradient descent, rescaling becomes important. Standardization can be implemented using the Z-score as follows:

$$z = \frac{x - μ}{σ} . \qquad ( 5.3 )$$

STWIP can be used to predict the expected ignition potential of a spatial location in period j, as discussed further.

A spatiotemporal wildfire ignition probability predictor can be provided by training a neural network with suitable problem objectives. Given a collection of sample points i with geospatial coordinates i.loc of (lat,lon) E historical ignition data, where features of the sample point i are known, the potential of a wildfire ignition at periodic intervals can be predicted. A model based on supervised learning of spatial, spatiotemporal and temporal features can be used to capture complex and non-linear interactions between WPVs using a deep neural network (DNN). The DNN can be a prediction algorithm of the STWIP. Unlike traditional methods of wildfire estimation with simple logistic regression, the DNN is capable of modeling non-linear correlations between the WPVs as illustrated in (5.4), and can update the network's basis functions in specific input space directions.

$$\hat{y} = σ ( {\sum }_{h = 1}^{H} {w}_{oh}^{T} h ( {\sum }_{i = 1}^{D} {w}_{hi}^{T} * {x}_{i} + {w}_{h 0} ) + {w}_{o 0} ) . \qquad ( 5.4 )$$

where w is the vector of adjustable weight parameters, with input variables xᵢ, σ is a threshold function, and {i, h, o} represent the input, hidden, and output layers. By adjusting the weight vector through different training epochs the predicted labels are mapped closer to the target labels, estimating the probability of potential wildfire ignition, π_{i,j}, as follows:

$${π}_{i , j} = f ( x ) . \qquad ( 5.5 )$$

The STWIP architecture can be implemented as a three layer fully connected network that utilizes an Adam optimizer, ReLU activation, and softmax activation at the output layer. The hidden layers' neurons can be chosen to avoid over-fitting and enhance prediction accuracy. The data input, x, is fed into the input layer. The output layer consists of two neurons that output probabilities of potential ignition/non-ignition in one hot encoded format. The network is trained and minimized over the cross-entropy loss. The trained STWIP is illustrated in Algorithm 6.

Algorithms 6 Batch Learning Based STWIP

| | |
|---|---|
| 1: | Given a training set (x₁, y₁), ..., (xₙ, yₙ) with features in instances |
| | xₜ ∈ Rⁿ, with label yₜ ∈ {0, 1} |
| 2: | Input(X,Y): A set of labeled input features [temp, ..., month], of |
| | training samples θ, batch size b |
| 3: | Output: The spatio-temporal ignition probability maps. |
| 4: | Hyper-parameter selection |
| 5: | function Predictor_Training(X, Y) |
| 6: | Shuffle ←enabled |
| 7: | $count\_max ← \frac{θ}{b}$ |
| 8: | count ← 0 |
| 9: | while count < count_max do |
| 10: | for batch b in θ do |
| 11: | STWIP ← DNN learns (b × [temp, ..., month]) |
| 12: | count + + |
| 13: | end for |
| 14: | end while |
| 15: | Compute accuracies |
| 16: | Compute the ROC AUC metrics |
| 17: | Apply STWIP to test samples |
| 18: | return Wildfire potential ignition maps of π_{i, j} |
| 19: | end function |

For wildfire spread estimation, modeling wildfire behaviors including spread, software such as Prometheus and Burn-P3 can be used, but may require predefined inputs such as initial ignition grids from all historical fires, the different ecoregions, percentage of escaped fires and more, which may not be readily available to the user. In literature, models such as the FLAME have been developed to rely on observable field assessments to consider areas of high fire spread rates. One model of the fire front uses a variation of the Thomas Equations shown in (5.6) and (5.7).

$${V}^{f} = \frac{k ( 1 + {V}_{w} )}{{ρ}_{b}} \qquad ( 5.6 )$$

$${r}_{i , j , ω , t}^{f} = {r}_{i , j , ω , i - 1}^{f} + {V}_{ω , t}^{f} Δ t cos ( {ϕ}_{i , j , ω , t}^{ω} ) \qquad ( 5.7 )$$

where Vw is wind speed, k is fire-type parameter, ρb is the bulk density, rf is the radius from the initial ignition point to the fire boundary, and $w is wind direction. However, if a wildfire ignites in a cell i in period j, its spread rate depends on surrounding fuel types and wind speed, which can be captured by the wildfire-fuel spread characteristics. An approximate radial spread rate can be adapted using the FireLine Assessment Method, that can be determined by assessing the fuel type and wind speed at each HRRR grid point nearest to the potential wildfire ignition location. In the present disclosure, instead of arbitrary values of spread rates, practical datasets that adapt the considered geographical area to different fuel types are utilized.

An area can be mapped to common fuel types, such as crown, litter, grass or other suitable fuel types, with spread rates modeled as a function of wind speed. Note that in the case of multi-fuel types such as litter and crown, the fuel type with higher spread rate can be chosen. Constant but atypical wind speed directed towards the power system components is assumed, in order to account for the worst case scenarios of wildfire spread in the spatiotemporal assessment.

A power grid wildfire risk assessment model can utilize the outputs of the wildfire estimation model. A wildfire potential ignition map (ignition probability map), such as one produced by the STWIP, can aid in proactive de-energization to prevent endogenous fires caused by power system failure, while the spread estimation aids improvement in adaptive operation of power grid against exogenous wildfires. Specifically, a set of grid component outage scenarios are first generated by incorporating the output parameters of the first stage estimation model with GIS information of the power grid. In particular, given πi, j, scenarios are sampled given the distribution of the wildfire potential ignition map and potential ignition locations, generating expected scenarios for the power system risk assessment model. Note that the granularity of πi, j can be improved to hourly depending on user application. In this paper, we estimate the hourly probabilities from πi, j as follows:

$${( 1 - {p}_{i , h} )}^{H} = ( 1 - {π}_{i , j} ) \qquad ( 5.9 )$$

where pi,h is the hourly probability of potential wildfire ignition in i, and H is the cardinality of hours in day j. Based on these scenarios, three risk metrics, namely, critical response time, scenario based damage cost, and expected damage cost are calculated to assess risk.

A power grid outage scenario generation of grid component c at time t of operational day j of the year can be modelled. Assuming that the wildfire ignition happens at time t*=0, to assess the operation of power grid for the subsequent 24 hours after the potential incident, if the potential wildfire occurs given scenario, s, and the spread rates given s are known component outages that can be induced or motivated by this fire can be estimated. Let πs denote the probability of occurrence of scenario s corresponding to a set Is j of potential ignition locations of day j. The spreading rate ωs i of the ignition in location i in scenario s is obtained by using the spread model presented herein with the corresponding values of forecast wind speed and fuel types around i. The GIS data of the power grid is mapped into the considered area. A component (e.g., transmission line) is assumed to be damaged if the potential fire crosses its safety zone Δc and the status of power grid component c is characterized by a scenario dependent parameter δs c,t as:

$${δ}_{c , t}^{s} = \{ \begin{matrix}0 , & if {min}_{i ∈ {I}_{j}^{s}} {D}_{c}^{i} - {ω}_{i}^{s} Δ t > Δ c \\ 1 , & if {min}_{i ∈ {I}_{j}^{s}} {D}_{c}^{i} - {ω}_{i}^{s} Δ t < Δ c\end{matrix} \qquad ( 5.1 )$$

where Δt=t−t*=t (t*=0) is the potential duration of the wildfire spread, Di is the Euclidean distance from the potential ignition point i to the grid component c, and ωsΔt is the spreading radius of the wildfire from its ignition point. Note that (5.10) considers potential wildfire ignition with spread closest to component c, since multiple ignition points can possibly occur in a scenario s, which was reportedly the case in the infamous Campfire. Also, when a component is on outage (δs=1), it can be assumed that it continues to be out until the end of the considered operation horizon. The value of Δc can be adapted from numerical determination of the Acceptable Safety Distance, which furnishes a detailed thermodynamics of wildfire effect on system components, informed by flame characteristics and a vulnerability threshold. The safety distance is informed by flame characteristics and a vulnerability threshold, and is the distance between the transmission line and the fire at which the thermal radiative flux is less than a given threshold, Φₜₕᵣₑₛₕ. The threshold value is set to the vulnerability of transmission lines. The safety adapted distance is determined by the following correlation:

$${D}_{x} ( opt ) = D ( 1 - exp ( - {p}_{thresh} \frac{2 L}{{l}_{f}} ) ) , \qquad ( 5.11 )$$

where pₜₕᵣₑₛₕ is a pre-determined empirical parameter for each Φₜₕᵣₑₛₕ, l_{f} is the flame length, 2L is the width of fire, and

$$D = \frac{{l}_{f} cos γ \sqrt{- 4 {Φ}_{thresh}^{2} + {( {BT}_{f}^{4} ετ )}^{2}}}{2 {Φ}_{thresh}} + {I}_{f} sin γ , \qquad ( 5.12 )$$

where τ is the atmospheric transmissivity, ε represents flame emissivity, B is the Boltzmann constant, and T_{f} is the average temperature of the flame.

Metrics for power grid wildfire risk assessment are developed to aid utility decision making process and operational strategies in the wake of a wildfire threat. Since the metrics are used for a particular operation day j of the grid, the notation j is omitted from hereon for simplifying the notation.

The critical response time (Δt) metric furnishes the time period within which utility operators can make operational changes to minimize economic damages before power shutoff is absolutely necessary. It is a function of the distance from the potential wildfire ignition point i to power system component c, and the wildfire rate of spread ωs as follows:

$$\overline{Δ t} = {min}_{∀ i ∈ {I}^{s} , s ∈ S} \frac{{D}_{c}^{i} - {Δ}_{c}}{{ω}_{i}^{s}} . \qquad ( 5.13 )$$

Note the importance of this metric since aspects of vegetation, fuel, and velocity of wildfire spread, based on the spreading model in (5.8), is incorporated into a time measure for optimizing utility actions pre-wildfire. The metric inadvertently provides a time estimate before the potential ignition will pose a risk, and serves in two ways depending on application. First, if Δt is <<threshold (utility defined, associated with Δc), then ignitable location is close to the power system component, ignition is possible within Δc and components should be de-energized to avoid being sources of ignition for endogenous wildfires. Secondly, if Δt is >>threshold i.e., distance of potential ignition is far enough from component, the utility can afford to wait pre-wildfire and not cut off power to customers, say H hours before actual ignition, which is mainly where revenue is lost during wildfire threats. Also for the latter depending on the critical time, utilities can operate and strategize before any potential exogenous wildfire fronts induce component outages.

For a scenario-based damage cost, the operational damage cost of a particular scenario s is the result of the optimal response of the power grid against the realized outage scenario. The operational damage cost includes losses in revenue accruing to the power utility due to lost opportunity costs arising from load curtailment, including power shutoff to customers and intended unavailability of power components, e.g., power lines, from wildfire threats. In the case of the power transmission grid, such scenario based damage cost can be defined as the optimal value of the following security constrained optimal power flow as below:

$${cost}_{s} = min {\sum }_{t ∈ T} {\sum }_{b ∈ ℬ} {VOLL}_{b , t} {LC}_{b , t}^{s} . \qquad ( 5.14 )$$

$$s . t .$$

$${P}_{l , t}^{s} = \frac{[ {θ}_{b , t}^{s} - {θ}_{{b}^{′} , t}^{s} ]}{{x}_{l}} ( 1 - {δ}_{l , t}^{s} ) , \qquad ( 5.15 )$$

$$∀ l = {bb}^{′} ∈ ℒ$$

$${P}_{g , b , t}^{s} - {P}_{d , b , t} + {LC}_{b , t}^{s} = {\sum }_{{bb}^{′} ∈ ℒ} {P}_{{bb}^{′} , t}^{s} , \qquad ( 5.16 )$$

$$0 \leq {LC}_{b , t}^{s} \leq {P}_{d , b , t} , \qquad ( 5.17 )$$

$$∀ b ∈ ℬ , ∀ t ∈ 𝒯$$

$$( 1 - {δ}_{g , b , t}^{s} ) {\underline{P}}_{g , b} \leq {P}_{g , b , t}^{s} \leq ( 1 - {δ}_{g , b , t}^{s} ) {\overline{P}}_{g , b} , \qquad ( 5.18 )$$

$$∀ g ∈ 𝒢 , ∀ b ∈ ℬ , ∀ t ∈ 𝒯$$

$$- ( 1 - {δ}_{l , t}^{s} ) {\overline{P}}_{l} \leq {P}_{l , t}^{s} \leq ( 1 - {δ}_{l , t}^{s} ) {\overline{P}}_{l} , \qquad ( 5.19 )$$

$$∀ l ∈ ℒ , ∀ t ∈ 𝒯$$

$${\underline{θ}}_{b} \leq {θ}_{b , t}^{s} \leq {\overline{θ}}_{b} \qquad ( 5.2 )$$

$$∀ b ∈ ℬ , ∀ t ∈ 𝒯 ,$$

$${P}_{g , b , t}^{s} - {P}_{g , b , t - 1}^{s} \leq {RU}_{g , b} , \qquad ( 5.21 )$$

$$∀ g ∈ 𝒢 , ∀ b ∈ ℬ , ∀ t ∈ 𝒯 ,$$

$${P}_{g , b , t - 1}^{s} - {P}_{g , b , t}^{s} \leq {RU}_{g , b} , \qquad ( 5.22 )$$

$$∀ g ∈ 𝒢 , ∀ b ∈ ℬ , ∀ t ∈ 𝒯 .$$

where B, L, G, and T denote the set of transmission buses b, transmission lines l, generators g, and time slots t. The objective function (5.14) is to minimize the load curtailment cost over all the sets of buses and the scheduling horizon where LC_{b,t}^{s} denotes the load curtailment in bus b in time t in scenario s and VOLLb,t denotes the value of loss load. The optimization is subject to the following constraints. The DC power flow constraints of the transmission lines l connecting bus b and b′ is captured in (5.15) where the scenario based outage status of the line l is represented by a binary parameter δ_{i,t′}^{s}. In particular, if the line is potentially damaged by the modeled wildfire, i.e., δ_{l,t}^{s}=1, there is no power flow on the line. Power balance constraint in bus b is captured in (5.16) where the power generated by P_{g,b,t}^{s} generated by g in b, minus the bus power demand Pd,b,t, plus load curtailment LC_{b,l′}^{s}, equals the total power flowing out of b. Additionally, the load curtailment at any bus must remain within the limitations of the total demand at that bus, which is presented in (5.17). The power generated by g is constrained by its minimum and maximum capacity as in (5.18). The power flow over the line l is constrained by its thermal capacity P̅ₗ as in (5.19). On a similar note, the upper and lower limit constraints of the bus phase angle θ_{b,t}^{s} are described in (5.20). Furthermore, the limitations RU_{g,b}, RD_{g,b} of the generators' ramping up and down rates are furnished in (5.21) and (5.22) respectively. Note that our framework can also apply to power distribution network where DC power flow constraints are replaced by the DisTFlow model considering line outage status.

The expected power system damage cost for a given set of wildfire motivated outage scenarios S is calculated as:

$$ECOST = {\sum }_{s ∈ S} {π}_{s} \times {cost}_{s} , \qquad ( 5.23 )$$

where costs is obtained by solving the optimal response of the power grid against the wildfire motivated outage scenario s, e.g. solving optimization problems (5.14)-(5.22) for the case of transmission networks. Hence, the ECOST metric, in addition to estimated infrastructure damage costs, can aid utility decisions of wildfire mitigation vs. restoration, i.e., informing the important question: should the utility use the “let-burn” strategies, since oftentimes the utility is burdened with the economic decision of either fighting wildfires or employing the “let-burn strategy” where the wildfire is allowed to burn and damages are rebuilt/restored. If the firefighting costs are greater than the expected damage costs (operational, infrastructural and otherwise), the utility could utilize the “let-burn” strategy.

Numerical results for a simulation considered an area covering approximately 200 km2 in northern California and spanning latitudes 38-49′17.616″N to 40-46′7.14″N, and longitudes 120-11′52.8″W to 122-43′55.2″W. The chosen area reflects a homogeneous climate yet spatially diverse in fuel and vegetation. The STWIP was trained and validated using a 70% and 30% split training data of 10,900 samples, and compared to other data-based conventional baselines, including decision tree, boosted decision tree, and linear regression. The wildfire estimation results are provided over the studied area to illustrate the effectiveness of the first stage of the framework, i.e., the STWIP model.

For wildfire estimation analysis, the performance analysis showed the average accuracy for training and validation of the STWIP was (98.31% and 97.0%), while the boosted decision tree was (93.27% and 92.0%), both outperforming other baselines. Also, the proposed STWIP achieves the best performance with an Area Under the Receiver Operating Characteristic curve (AUC) of 0.995. Note that the AUC describes the model trade-off in terms of sensitivity and specificity. This performance is followed again by the boosted+tree algorithm with an AUC of 0.965 and the regression with an AUC of 0.903 respectively.

Next, the STWIP was tested with the 2018 year data, comparing results with the actual wildfire occurrence currently available in data sources. In the test data, the 15th day of the month was used as representative of its wildfire characteristics. Similar patterns of spatial density and temporal distribution can be obtained, and predicted hotspots are similar to the actual historical test year, clustered between latitudes and longitudes (39° 30′ 00″ N, 122° 30′ 00.0000″ W) and (39° 30′ 00.0000″ N, 121° 30′ 00.0000″ W). The central valley area of northern California has less ignition clusters, which is attributed to limited elevation and fuel. Similarly, the temporal results were analyzed monthly and showed that the estimated temporal distribution well follows the test year's actual temporal wildfire distribution (approximately Gaussian). Hence, by employing the STWIP for analysis as opposed to the conventional utility predefined fire threat areas and fire threat levels, power systems can further improve wildfire forecast and analysis towards actual expectations.

The percentage weighted impact of WPVs on the wildfire ignition status were evaluated based on their weighted influence on wildfire occurrence. Terrain and temperature, and cloud type and historical ignition, have the highest and least influence, respectively. Also, humidity seemingly influenced daily wildfire ignition maps produced by the predictor, especially in the central valley of northern California. This suggests which measurement types (sensors in monitoring corridors) that the power utility should invest for enhancing situational awareness against wildfire. The performance of STWIP is further underlined as linear methods such as regression do not well capture terrain which is indeed a high impact feature.

Conventionally, a utility often uses region-scale and deterministic threat level analysis as previously discussed. In this situation, as seen in the “conservative” utility case, the utility will have an extreme alert since there are more wildfire threats as opposed to the elevated threat area. The customers in the area with extreme alert will have their power shut off for the duration of the wildfire threat, including customers up north (relatively farther) from the wildfire threat cluster. The magnitude of the shut off can be visualized given the size of the predefined threat areas in a sample utility wildfire awareness issue. However, the potential ignition map and spread parameters provided by the first stage estimation model can be used to analyze the risk of over de-energization motivated by power component failure-ignited wildfires and the risk of outages induced by exogenous wildfire. With the granularity in spatial detail of the wildfire potential probability maps, the spread model, and the proposed risk assessment, the utility can optimize the time before shut off is necessary in exogenous fires, and also emulate the distance between a potential ignition location (ignitable location) and the power equipment in endogenous/equipment-induced wildfires. The analysis is conducted on a 24-bus test system mapped to span the length and breadth of the studied area, however, this analysis can be done on any suitable transmission or distribution system given complete system details.

Two case studies are considered which deviate from the power system normal operation when there are no wildfire threats. In case 1, the test system is simulated with the current conventional “conservative” utility approach of threat area and levels. In this case, all the power components located in the pre-defined elevated threat area are intentionally outaged whether or not they are in the direct vicinity of high wildfire potential. This simulates current utility procedure to prevent endogenous wildfires. In case 2, the wildfire analysis and test system de-energization is based on the wildfire potential ignition map produced by STWIP as described herein aim to improve spatial granularity and optimize (shorten) the time span of utility de-energization. Simulation data is based on Nov. 10, 2018. The VOLL is set to 1000 $/MWh. Details of the components that are out of service in the three case studies are shown in Table 5.2.

TABLE 5.2
Wildfire-motivated De-energization: Scenario of
public safety power shutoff aided by STWIP (case 2) vs.
conventional utility methods (case 1).

| | | Generator |
|---|---|---|
| Case Study | Transmission Line Outages | Outages |
| Case 1 | L1-4, L6-8, L14, L19, L24-33 | G1-4, G15-29 |
| Case 2 | L4, L8, L19, L23-24, L28, L31-33 | None |

To assess risk of outages induced by exogenous wildfire, a probabilistic ignition map is used to generate wildfire ignition scenarios and simulated spreading pattern, thus modeling exogenous wildfire-induced damages on power grid components. The expected damage cost, ECOST, represents the aggregate analysis for one operational year of the test system in the studied area. It shows that the power system is highly vulnerable during summer time from June to September, and quite low during winter time from December to March. However, the risk of wildfire induced outage still exists during non-summer times, which can be explained by the impacts of the time independent WPVs such as landuse and terrain. Hence, an efficient allocation of utility wildfire monitoring resources should be based on spatio-temporal analysis of wildfire occurrence, e.g., monitoring grid and vegetation should be done more frequently during high risk period.

To enhance de-energization decisions for power component failure-ignited wildfires, it is recognized that wildfires can be ignited by electric power line faults that cause arcing in a high-heat release of energy. Such incidents are majorly caused by ignitable vegetation contacting power lines. Indeed, the correlation between the wildfire ignition probability map and electric power failures motivates the use of proactive de-energization of equipment as a preventive measure. The improvements in de-energization using the proposed STWIP are illustrated, which is more granular and stochastic, when compared to the conventional utility approach. The proposed framework aids in enhancing de-energization and estimating the potential cost of wildfire occurrence, as detailed further.

The total system energy consumption, total load shed, and load shed-bus localization of the three cases were modelled. The total energy demand of the system was 54358.679 MWh, with case 1 supplying 29449.051 MWh due to large amounts of load shedding, 45.8%, resulting from the conventional threat area and threat level methods. Relative to case 2, the power grid response avoids a large amount, 19798 MWh, of unnecessary load shedding. Hence, a more detailed wildfire potential ignition map provided by the proposed granular analysis results in less conservative shutoff, i.e., only components in the high wildfire vicinity are proactively de-energized to prevent component failure-caused wildfire. Table 5.3 presents load shedding cost, and generation cost for all cases. For the normal system operation, there are no load shed costs and generation costs are $568,084.40 The total costs for case 1 is high due to the amount of load shed and the increase in production of expensive online generators.

TABLE 5.3
Costs for cases 1 and 2 ($)

| | Load Shedding | Generation |
|---|---|---|
| | Cost ($) | Cost ($) |
| Case 1 | 181,591.25 | 537,969.01 |
| Case 2 | 37,263.75 | 537,991.32 |

In addition, the framework aids improve the resilience of the system by spatiotemporally informing the disaster progression phase of the resilience trapezoid, hence reducing the “dip” in the resilience curve. Specifically, in case 1, a large and sudden drop of the percentage load served (performance indicator) is observed. This is because without spatiotemporal analysis, the utility performs conservative forced outages as soon as a wildfire threat is observed in their pre-defined regional threat areas, which in this simulation is set to the beginning of the scheduling horizon at t*=0. The percentage load served in case 2 is observed to reduce over time. This is possible due to the improved granularity provided by spatiotemporal analysis where expectations of wildfire parameters such as distance, spread rate, and the critical response time have been pre-estimated as discussed herein. Hence, with a grasp of the expected critical response times, the utility operations have increased and informed time flexibility in forcing component outages.

The present disclosure proposes a comprehensive spatiotemporal framework for power system wildfire risk analysis including two sequential models. The first model estimates the granular and spatiotemporal potential wildfire probability and spread based on influential parameters such as vegetation and fuel, wind speed, geographical and meteorological variables, while the second model leverages the estimated probabilistic ignition maps in order to analyze system risk from exogenous wildfire and to enhance power system de-energization in mitigating endogenous fires induced by power equipment failures. Numerical results show that lower forced electricity outages to customers can be achieved by increased granularity in spatial locations in utility service areas. Hence, the framework significantly improves utility de-energization decision compared to the current “conservative” threat area approach In addition, the framework aids to improve system resilience and utility revenue and prioritize resource allocation given increased localization of high wildfire potential.

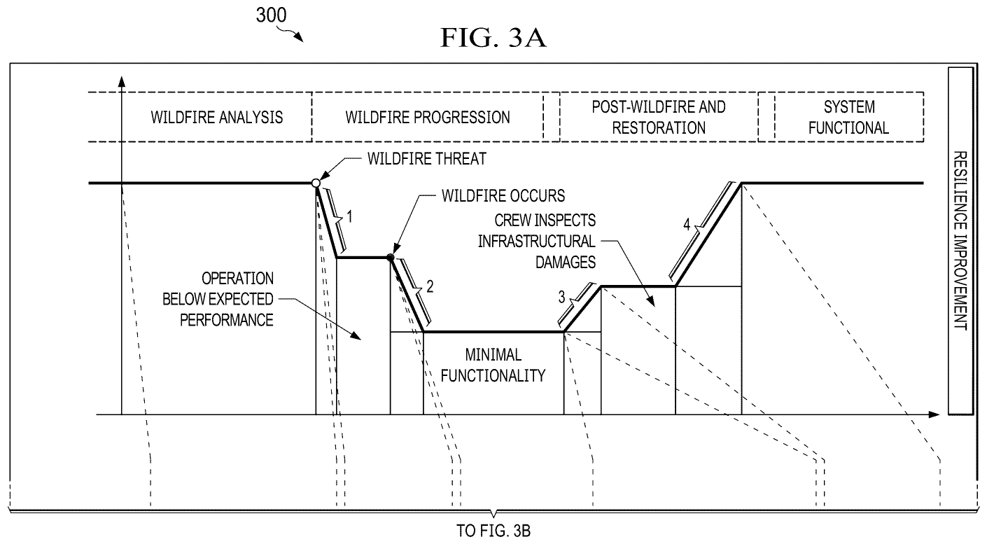

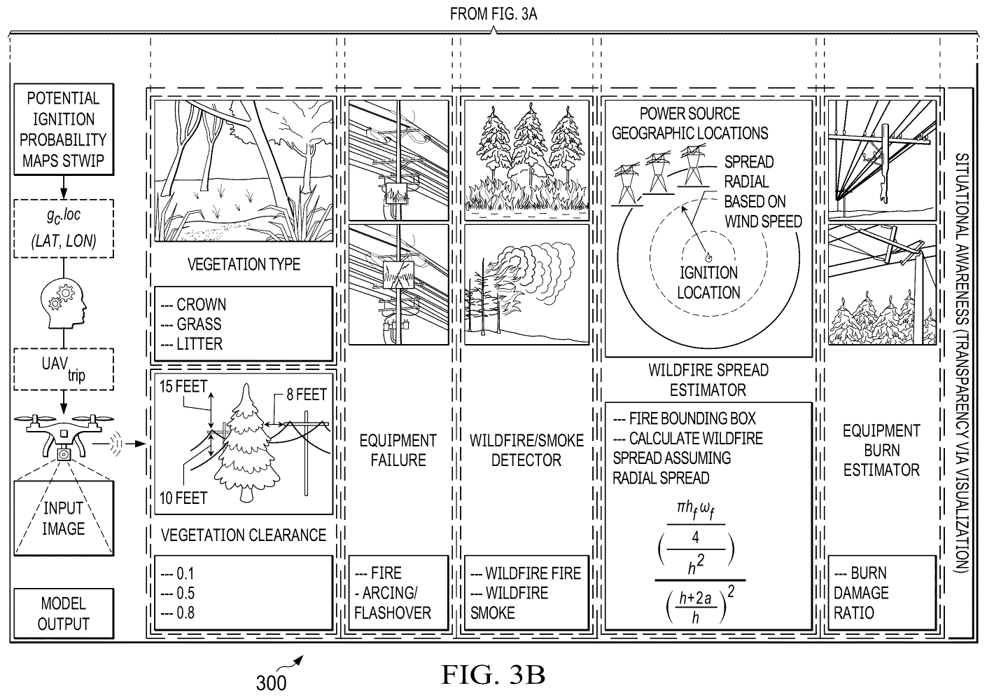

FIG. 3 is a diagram of a Self-Sufficient Low-Cost Power System Wildfire Resilience (SL-PWR) system 300, in accordance with an example embodiment of the present disclosure. A spatiotemporal wildfire ignition predictor (STWIP) is disclosed to produce wildfire potential maps that identify the probabilities for wildfire threats. The STWIP is also integrated with the disclosed SL-PWR system 300, as illustrated in FIG. 3, whereby the output of the STWIP is used by the SL-PWR to optimize UAV operation.

This disclosure further provides an intelligent and novel self-sufficient and low-cost system and method (SL-PWR) to guide and improve resilience in the wildfire response of power utilities. The SL-PWR can include 4 major modules:
1.) the vegetation module
2.) the power equipment module
3.) the wildfire module
4.) the burnt equipment module

These modules can be active in the resilience phases of the system, including pre-wildfire (wildfire analysis), wildfire progression, and restoration phases. The modules can also be made up of sub-modules which consist of CNNs that extract spatial details for detection, classification, estimation, and localization. As shown in FIG. 3, the SL-PWR can receive granular mapped spatiotemporal information of wildfire potential in a given service area which has been divided into grid cells with grid centers located at gc.loc with a latitude and longitude (Lat, Lon) at which UAVs can be situated to monitor that particular grid. SL-PWR uses the gc.loc's with extreme/elevated wildfire ignition probabilities to optimize the trips of the UAV to these grids to monitor and capture input images for important analyses in the comprehensive resilience enhancement provided by the proposed mitigation model. The SL-PWR performs analysis in real time with computation time that can be easily integrated into power system operations in order to prevent wildfire occurrence and mitigate impact. This function is achieved via automated vegetation management and equipment monitoring or in the case where wildfires occur, hasten the resilient response of the power utilities' mitigation resources by providing information on the fire type (e.g., fire accompanied by thick smoke will induce additional precaution in the area during evacuation or firefighting), fire area, fire location and spread. The proposed model also aids in transparent inventorying during post-wildfire restoration e.g., instead of contracting manual road crews to take inventory of damaged equipment which the sys-tem operator will be blind to, the SL-PWR can aid transparency, in that the system operator will be able to visualize and estimate damage cost through the images captured and analyzed by the “Burnt Equipment Detection and Estimation Module” and can hasten and automate the process.

The methodology of the SL-PWR includes example structures of the CNN or other suitable machine learning algorithm. A CNN can be used to provide a network to obtain spatial attributes used to train the SL-PWR. It is a deep learning algorithm that takes in an input image and assigns learnable parameters (weights and biases) to various aspects/elements of the image so as to differentiate one image from another. It is a multi-layer neural network that consists of convolution layers, pooling layers and fully connected layer. The convolution layer(s) are made up of N @ F×F filters which basically translates to a matrix of weights called feature maps. In order to generate these feature maps, the filters (a pre-defined matrix initialized with height and width parameters) travel left to right on the input image/map, stepping in strides of predefined width and taking the dot product of the applied filter/kernel and the image/feature map area overlapped by the filter, after which it moves downward with step size of a predefined stride height and repeats the step across the image (i.e., from left to right). The CNN operator at each layer can complete the following function or other suitable functions:

$${Y}_{ij}^{\hat{x} \hat{y}} = A ( {b}_{ij} + {\sum }_{F - 1}^{} {\sum }_{\hat{q} = 0}^{F - 1} {ω}_{ij}^{\hat{p} \hat{q}} {X}_{i - 1}^{( \hat{x} + \hat{p} ) ( \hat{y} + \hat{q} )} ) \qquad ( 6.1 )$$

where the layer under consideration is i, j is the feature map under consideration in layer i, Y x,y is the output located at position (x, y) in feature map j and layer i, A(−) represents the layer's activation function, bij is the bias term, ωpq denotes the weights/value of the convolution filter (F×F), at position (p, q), associated with layer i and feature map j. In the event where the filter size and stride would leave certain parts of the input unattended, padding can be applied. This creates the output volume from each convolution layer given the filter size, padding, and stride, according to (6.2):

$$Out\_Vol = \frac{( I - F + P )}{S} + 1 \qquad ( 6.2 )$$

where I is the input volume of the I×I image, F is the kernel size (volume of the filter, [F<I]), P is the padding and S is the stride. Hence, by convolving the filters with the input image and carrying out non-linear transformations using activation functions, N feature maps are created. The activation function adopted in the proposed model is the ReLU (Rectified Linear Unit) function as in 6.3.

$$A ( x ) = max ( 0 , x ) \qquad ( 6.3 )$$

The pooling layer(s) performs its pooling operation by obtaining the average or maximum value of the elements of the feature map where its window slides, given the kernel size (height and width) of the filter and the strides. Hence, this layer extracts the dominant features, a dimensionality reduction of sorts which also helps to improve computational efficiency. Together, the convolutional layer and the pooling layer form the ith layer of the CNN. The fully connected layer is one that learns the non-linear combinations of these high-level features as transformed by the convolutional layer, hence, learning a non-linear function. It takes in the elements of the feature maps feeding directly into it and then flattens these elements towards the output which could be classification or regression type. The flattened elements are then fed into a feed-forward neural network, learning the parameters (o, b) by minimizing the negative log-likelihood given the training input as in (6.4).

$$L ( ω , b ) = - {\sum ln}_{{I}_{k}} p ( {I}_{k} \vert {I}_{k} ; ( ω , b ) ) \qquad ( 6.4 )$$

where Iₖ is the correct (target) class label for the input image under consideration. This objective is optimized by applying applying stochastic gradient descent with back propagation using the chain rule as in (6.5), to training iterations over several epochs.

$${ω}_{i}^{n + 1} = {ω}_{i}^{n} - μ \frac{\partial L}{\partial {Y}_{{N}_{i}}^{n}} \cdot \frac{\partial {Y}_{{N}_{i}}^{n}}{\partial {Y}_{( {N}_{i} - 1 )}^{n}} … \frac{\partial {Y}_{i}^{n}}{\partial {ω}_{i}^{n}} \qquad ( 6.5 )$$

where μ is the learning rate, Ni is the total number of layers in the network, Y n is the output of layer i during iteration n. With this process, the model is then capable of distinguishing dominant and less-superior features in the input images, further classifying them using the Softmax function, an adaptation of the Sigmoid function used for multi-class classification, which takes in the vector of R real numbers and normalizes them into a probability distribution of N probabilities which are proportional to the input exponentials as in (6.6):

$$p ( c \vert {I}_{k} ; ( ω , b ) ) = \frac{{e}^{{f}_{c} ( {I}_{k} ; ( ω , b ) )}}{{\sum }_{d = 1}^{N} {e}^{{f}_{d} ( {I}_{k} ; ( ω , b ) )}} \qquad ( 6.6 )$$

where fc(Ik; (ω, b)) is the scores from each of the multiple classes of interest c∈{1, . . . , N} transformed into conditional probabilities using the Softmax function which applies the exponential function to the elements of its input vector and divides the obtained value by the sum of the exponentials of all elements (normalization) which ensures the output components sum up to 1. In order to test the CNN model after the training process described above, the output layer then predicts the label I of the image input I using the argmax of the Softmax-transformed probabilities as in (6.7).

$$\hat{I} {=}_{c ∈ \{ 1 , … , N \}} p ( c \vert I ; ( ω , b ) ) \qquad ( 6.7 )$$

The proposed SL-PWR consists of sub-modules which are built fundamentally based on the Residual Neural Network (ResNet18).

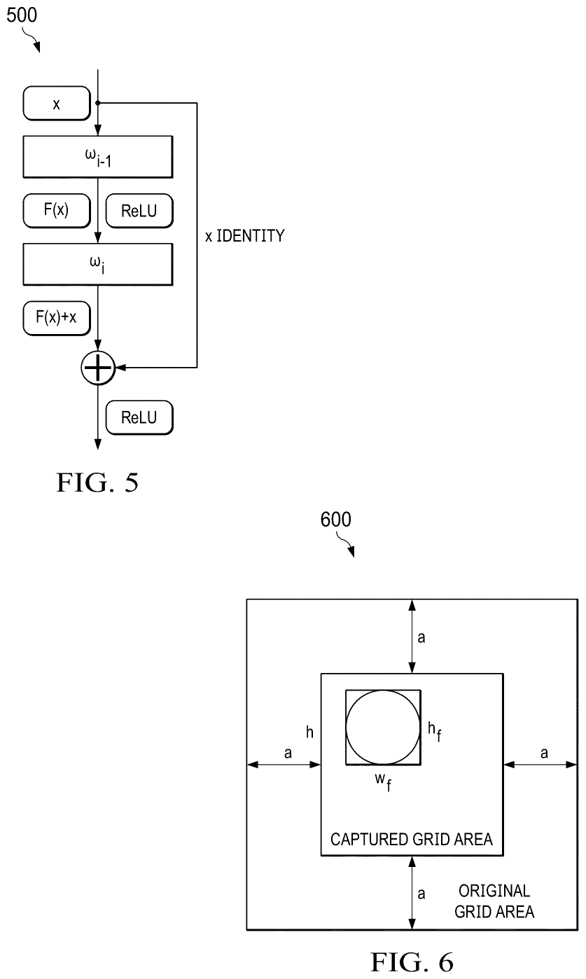

FIG. 5 is a diagram of a system 500 for implementation of an identity shortcut connection via the residual block to avoid the depreciating performance of having many convolutional layers, in accordance with an example embodiment of the present disclosure. ResNet18 has been widely applied to different image vision and classification problems, as it provides a solution to the issue of vanishing gradients, which can occur as continuous multiplication during back-propagation makes the gradients infinitesimal as neural networks get deeper [182]. As shown in system 500, the block tries to learn an output, say Gx. The residual block allows the network to directly learn F (x)=G(x)−x, such that the target output is F (x)+x hence avoiding depreciating performance that having too many convolutional layers would have introduced. For instance, in the block in system 500, the residual mapping function can be used as shown in (6.8), while the output of the block after the second ReLU activation is as furnished in (6.9).

$$F = {ω}_{i} σ ( {ω}_{i - 1} x ) \qquad ( 6.8 )$$

$$Y = F ( {x}_{ii} ) + x \qquad ( 6.9 )$$

where σ is the ReLU activation function. Given the “identity shortcut connection”, the network can skip one or more layers in order to avoid performance degradation birthing different variants including the ResNet18 and ResNet34 proposed in [182]. In this work, we employ the ResNet18 model as its performance is comparable with other networks [183] such as the ResNet34 but with relatively faster convergence. The architecture of the ResNet18 model employed in this paper is as shown in Fig. 6.2. This architecture is then adapted as required for the different sub-models of the proposed model.

In regards to loss functions, since stochastic gradient descent (6.5) is used in training neural networks, a loss function has to be selected during model design and configuration. In this work, the loss functions are chosen according to the classification type/output requirements of the specific model.

L1 Loss: This represents the average of all absolute differences between the true value y(i) and the predicted value y(i). Also called Mean Absolute Error (MAE), it measures the average of residuals in the dataset. We use the L1 loss for illustrations because it is not affected by the outliers as the L2 Loss Function is.

$${Acc}_{1} = \frac{1}{N} {\sum }_{i = 1}^{N} \vert {𝓎}^{( i )} - {\hat{𝓎}}^{( i )} \vert \qquad ( 6.1 )$$

Mean Square Error: The mean square error (MSE) is the L2 loss used to minimize error as the average sum of the all the squared differences between the actual/ground truth value and the predicted value as in (6.11). In this work, the root mean square is used to evaluate how far away (deviation) the target image's pixels are from the predicted image's pixels.

$${Acc}_{2} = \frac{1}{N} {\sum }_{i = 1}^{N} {( {𝓎}^{( i )} - {\hat{𝓎}}^{( i )} )}^{2} \qquad ( 6.11 )$$

Root Mean Square Error: The root mean square error (RMSE) is the square root of the MSE and measures the standard deviation of residuals in the dataset.

$${Acc}_{2} = \sqrt{\frac{1}{N} {\sum }_{i = 1}^{N} {( {𝓎}^{( i )} - {\hat{𝓎}}^{( i )} )}^{2}} \qquad ( 6.12 )$$

The Cross-Entropy Loss: The cross-entropy loss as formulated in (6.13) is also known as the logarithmic/log/logistic loss and is one popularly used for classification. This loss is used in this work for different reasons including: 1.) classifications that use sigmoid or softmax activation functions, which are more robust with improved performance using the cross-entropy loss [184], 2.) the problems are multi-class classification. The function outputs 1 when the network predicts the correct image and is 0 otherwise, in a one-hot encoded format.

$${L}_{CE} = - {\sum }_{i = 1}^{N} {\sum }_{j = 1}^{K} {𝓎}_{j}^{( i )} \cdot log {\hat{𝓎}}_{j}^{( i )} \qquad ( 6.13 )$$

Where yⱼ⁽ⁱ⁾ and ŷⱼ⁽ⁱ⁾ are the one-hot encoded actual classification and predicted outputs, j is the number of classes (for multi-class), and i represents the data points. Hence, the cross-entropy measures the error between two probability distributions under the maximum likelihood framework is derived for multi-class classification as:

$${P}_{model} ( Y \vert X , θ ) = {\prod }_{i = 1}^{N} {\prod }_{j = 1}^{K} {( {\hat{𝓎}}_{j}^{( i )} )}^{{𝓎}_{j}^{( i )}} \qquad ( 6.14 )$$

$$log {P}_{model} = {\sum }_{i = 1}^{N} {\sum }_{j = 1}^{K} {𝓎}_{j}^{( i )} \cdot log {\hat{𝓎}}_{j}^{( i )} \qquad ( 6.15 )$$

Let l⁽ⁱ⁾ be the correct class for the l^{th} example e.g.,

$${𝓎}^{( l )} = ( \begin{matrix}1 \\ 0 \\ 0\end{matrix} )$$

and the first class i^{(l)} is the correct class,

$$log {P}_{model} = {\sum }_{l = 1}^{N} log {\hat{𝓎}}_{{i}^{( l )}}^{( l )} \qquad ( 6.16 )$$

Using the softmax model:

$$log {P}_{model} = {\sum }_{l = 1}^{N} log {softmax ( z )}_{{i}^{( l )}} \qquad ( 6.17 )$$

$$log {P}_{model} = {\sum }_{l = 1}^{N} \frac{{e}^{{z}_{{i}^{( l )}}^{l}}}{{\sum }_{j} {e}^{{z}_{j}^{i}}} \qquad ( 6.18 )$$

$$log {P}_{model} = {\sum }_{l = 1}^{N} [ {e}^{{z}_{{i}^{( l )}}^{l}} - log {\sum }_{j} {e}^{{z}_{j}^{i}} ] \qquad ( 6.19 )$$

$$log {P}_{model} = {\sum }_{l = 1}^{N} [ {z}_{{i}^{( l )}}^{l} - {max}_{j} {z}_{j}^{i} ] \qquad ( 6.2 )$$

which is basically the error distance.

For metrics, the accuracy of the multi-class classification is evaluated as in (6.21) by using the score function defined as the mean of the sum of correct predictions over the sample size N. Similarly, the accuracy of the regression problems is evaluated by using the average L1 distance as in (6.22):

$${Acc}_{1} = \frac{1}{N} {\sum }_{i = 1}^{N} {\sum }_{j = 1}^{K} {𝓎}_{j}^{( i )} \cdot {\hat{𝓎}}_{j}^{( i )} \qquad ( 6.21 )$$

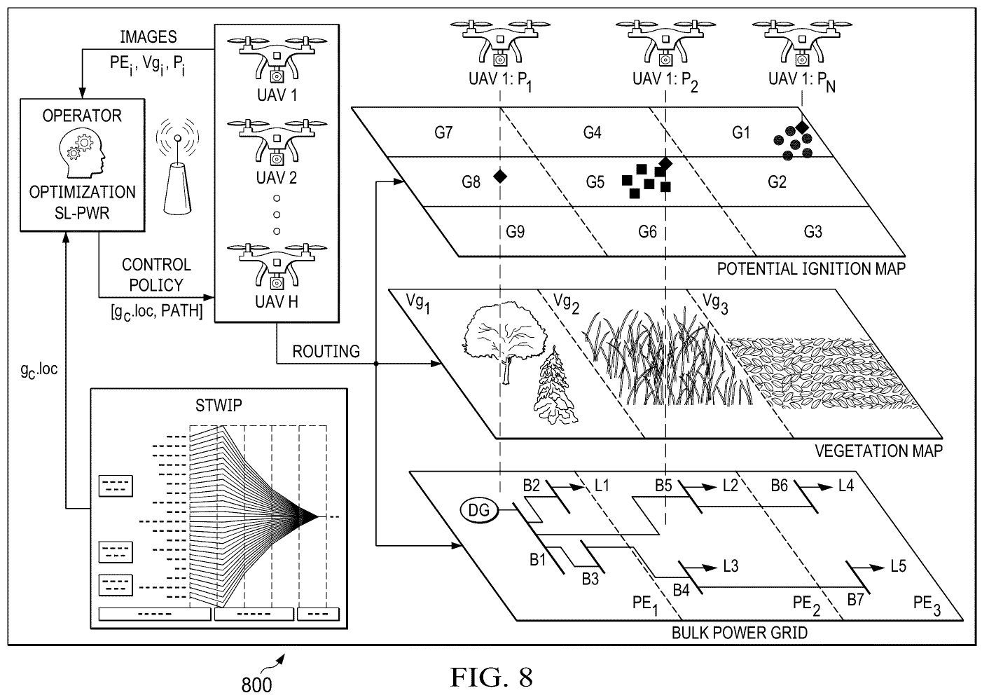

For UAV resource integration to SL-PWR and quantitative input data from STWIP, the spatial definitions of quantitative input data are addressed. The STWIP produces wildfire threat maps which provides potential ignition locations (i.loc) with their probabilities ([0,1]) of ignition readiness. A spatial location is a point i with geospatial co-ordinate i.loc defined by a latitude and longitude (lat, lon) at any location in a grid cell. Grid cells here are g×g km polygons which have uniform past spatiotemporal wildfire characteristics and a centroid. Each grid centroid also has geospatial coordinates gc.loc. The STWIP provides the grid centroids gc.loc with different levels of wildfire threat according to the potential ignition probabilities (wildfire threat/wildfire risk) of all i.loc located within the grid. For instance, in FIG. 8, on the potential ignition map, the grid G1 contains high risk locations while G5 contains moderate risk locations, hence G1 is an extreme risk grid, G5 is an elevated risk grid and all other grids are normal with little to no threat. The STWIP then sends this information (gc.loc, risk level) as input to the UAV navigation for visual inspection. The information can further be used in optimizing the UAV monitoring routes as proposed herein. When the trip information gets to the UAVs, they begin their monitoring travel along the specified paths taking images from gc.loc. We assume that at the UAVs' capture location, gc.loc, the entire grid can be monitored.

For the UAV image capture, utilities occasionally perform visual inspection using manual field surveys like foot patrol crew and manned helicopters, for vegetation management and monitoring power equipment. More advanced techniques have also been employed in literature including aerial images from manned helicopters and fixed-wing platforms, land-based platforms, airborne laser scanner, synthetic aperture radars, optical satellite, and UAVs. Land-based platforms include techniques that utilize mobile platforms such as cars, integrating different navigation, locational and imaging data sensors. Additionally, helicopters and fixed-wing aircraft have been typically used for power line inspection and vegetation monitoring respectively. Airborne laser scanning technique is also basically active remote sensing from an aircraft using Light Detection and Ranging (LiDAR). Satellite image data can also be employed e.g., satellites orbiting at lower (500-2000 km) altitudes can detect wildfires in the early phases due to their finer resolution but these satellites can take several hours to days to return to the same view. For example, VIIRS has a 12-hour revisit time while the Landsat-8 has a 16 day revisit time hence it is rare that one of these satellites provides the first wildfire alerts. Using satellites have additional limitations including:
1. The detected heat signatures are averaged over pixels, making it difficult to pinpoint fire location and size.
2. Wildfire intensity is indicated by thermal signals which can be smoldered by smoke and hence radiate relatively less energy, causing data misinterpretation.
3. At lower altitudes (up to 215m) UAVs can capture 5 cm resolution imagery, which is much higher than imagery captured from satellites, 25 cm resolution.

Helicopters and airplanes can also be used as conventionally done by power utilities, however, low-flying airplanes can capture comparable imagery to UAVs, but are expensive to hire and flying at low altitudes increases the possibility of a crash. Employing UAV technology lowers costs and improves operator safety for such missions.

UAVs thus provide the following advantages:
1. UAVs provide more continuous monitoring than satellites, which periodically visit specific parts of earth.
2. UAVs would rarely be blinded by local weather conditions or smoke/dust of wildfires.
3. Satellite imagery e.g., from Google Earth can only support limited detail in the image resolution before images begin to appear blurred or pixelated.
4. Most UAVs do not need runways, takeoff can be from car-top launcher and recovery with parachute, if needed.

Additionally, although microwaves from synthetic aperture radars, also obtained from earth observation satellites, are capable of penetrating clouds, the UAVs are cost efficient for visual inspection and have widely been employed by power utilities.

With the UAV-enabled SL-PWR, the vehicles fly over the service area using the optimization model proposed herein. The geographical layout of the service area is also defined herein. The image attributes (image, gc.loc (lat, lon)) are then sent as output from the UAVs and input to the SL-PWR via a communication link e.g., cellular communication or leased lines from internet service providers (ISPs) since they provide more redundancy (availability of various ISPs) in a wildfire scenario. As the UAVs fly over, the images (vegetation, endogenous ignition source, fire spread/smoke, burn-damaged equipment) are captured from different scales/angles and taken at different times of day and weather conditions. To capture these conditions, diverse images are collected and augmentations/transformations are applied, which also serves to increase the training data.

UAV control is performed in the mission planning “ground station” software which can easily run on Windows PCs. The software enables the operator plan and upload missions to UAVs wirelessly, launch the UAVs, monitor trip progress and issue landing commands. Specifically, photogrammetry tools in the software can be used for the mission planning and route specification after route optimization. In this tool, the aerial image of the service area to be monitored is highlighted within a rectangle, producing a preview of the proposed flight paths using waypoints which signify the UAV turning points in the trip. Typically, “no waypoints zones” (e.g., close to major airports) are also indicated by the software so as to mitigate the UAV flying into restricted airspace. After confirmation, the trip is uploaded wirelessly to the UAV via a datalink which creates a communication bridge between the control software PC and UAV. The UAV can then be launched, its trip monitored through each waypoint, and automatically landed upon trip completion via the software. Furthermore, the captured image's geographical coordinates is also recorded since the GPS receiver avails the UAV positional data along with the images which are sent to SL-PWR for analysis, detection and estimation.

For image acquisition and processing, databases exist for wildfire detection, such as a smoke dataset, NASA's quantitative forecast data, image data of wildfire hotspots detected by NASA satellites and the Fire Information for Resource Management System. However, no known database captures SL-PWR input requirements including utility equipment, wildfire fire-smoke, vegetation type and clearance data. Therefore, image acquisition and processing is a significant effort in the training of the SL-PWR and the generated database provides an important technical contribution. Search engines can be scraped for RGB image data of different pixels using the SL-PWR python scraper code for image collection and relevant images can be retained. In tests, input data consisted of over 1800 original images including 863 images, 307 vegetation type images, and 286 images for the burnt equipment detection and estimation module. Additionally, there were 283 vegetation distance dataset images, 125 images for fire spread prediction, and 286 images for the burnt equipment detection and estimation module.

The images can then be resized to the input size requirement of the network, such as the ResNet-18 network at 224×224 pixels which have 3 (RGB) color channels. The resizing unifies the images also. A Python function can be used to convert all images to size 224×224×3 with a .jpg image extension. Other functions can also be used to perform center crop, resize and normalize with ImageNet dataset statistics with average and standard deviation of mean=[0.485, 0.456, 0.406] and std=[0.229, 0.224, 0.225] per channel, respectively.

The data is labeled to the ground truths as the training is supervised. Qualitative/categorical labels are transformed to quantitative data points e.g., crown=1, grass=2, litter=3.

The data is then uploaded to google drive from where it is imported into the google Colabo-ratory platform which affords the GPU computation required for the model analysis. The data is then sliced into the different categories of the multiple classes. After importing the data, each data class/category is shuffled in order to randomly rearrange the data and avoid bias towards particular classes by utilizing an unbiased data distribution.

For data augmentation, the input data amount for each of the SL-PWR modules can be increased by slightly modifying copies of already existing input images using different techniques such as horizontal flipping, random cropping, color normalization and jittering. Random cropping can be applied by first inputting (224+x)×(224+x) pixel images and then cropping at fixed (cropping by moving towards the four edges and then a center crop) or random locations, to get 224×224 images. Also, inputting 224×224 images and then adding horizontal and vertical padding to the images can be used, and then the crop can be applied to fixed or random locations on the image. Specifically, color normalization sets the lowest-highest intensity pixels from values of 0-255 while pixels in all 3 channels are then scaled accordingly. The color jittering changes the image parameters following a normal distribution with zero mean and different standard deviations which change the image brightness, contrast, saturation, and hue, respectively. This gives the image different contrasts which represent images captured by the UAV at different times of the day, and different diurnal weather conditions respectively. Gaussian blur augmentation was added to make the model sturdy against weather conditions such as fog, mist, etc. These techniques also perform as regularizing parameters to reduce model overfitting.

A data split function can be used according to the input data in the different categories in order to randomly split the dataset to avoid predictability in the dataset and hence over-fitting and ensure that bias is mitigated in cross-validation as well as evaluate the model accuracy with different random dataset distributions. In this operation, 100% of the data is added to a split termed “all,” a smaller percentage such as 60% of the data can be added to a split termed “train” for the training dataset, another smaller percentage such as 20% of the data can be added to a split termed “val” for the validation dataset, and another smaller percentage such As 20% of the data is added to a split termed “test” for the testing dataset, or other suitable data sets can also or alternatively be used.

The SL-PWR includes four main modules:
1) the vegetation module
2) the wildfire module
3) the power equipment module, and
4) burnt equipment detection and estimation module.

These modules also include sub-modules which are used to improve the system resilience at different phases of the resilience trapezoid as illustrated in Fig. 6.1. These models and their sub-models are further described as follows.

The vegetation module can be active in the wildfire analysis stage of the resilience trapezoid. Vegetation is one of the most abundant biotic elements and refers to the plant life of a region. It is the ground cover provided by plants and is necessary for shaping the ecosystem. However, given the above and even enhancing environmental beauty, different types of vegetation (e.g., needle leaf forests, shrub lands, savannas) can also cause issues for the electric power utilities when they grow close to overhead power lines which are not protected by insulation. When these trees and it's limbs (branches, etc.) fall, they could also bring down power lines and other electrical equipment leading to power outages or in a worse case cause arcing and fires on the lines, or become a direct pathway for electricity, which can in turn cause wildfires. Electric power utilities hence perform vegetation management on thousands of miles of overhead power lines through careful pruning of trees, or removal of vegetation that could interfere with power lines. Moreover, the Federal Energy Regulatory Commission (FERC) has granted the North American Electric Reliability Corporation (NERC) the authority to audit annual vegetation management plans for lines carrying≥200 kV and levy fines to ensure the plans meet standards. Additionally, there are professional standards, established by the American National Standards Institute and the International Society of Arboriculture, for vegetation management which the utilities follow. Utilities employ the services of certified arborists to provide some level of supervision to the professional tree-trimming crew who are contracted for vegetation management projects which could be within intervals of 4-5 years, or less for vegetation that is fast growing.

A vegetation type detection sub-module can be used to distinguish between different vegetation types which can serve as fuels for wildfires. In order to simplify analysis, vegetation types can be grouped to a small number of types, such as crown, grass, and litter. This logic is also efficient because of the types of wildland fires, namely crown fires, surface fires, and ground fires, which can be associated with these categorical vegetation types. Additionally, classification can help the fire crew easily recognize vegetation types, recognize the fuel characteristics of the vegetation, and also the rate of spread characteristics. The vegetation type model not only helps with the vegetation management plan drawn by the arborists but also helps with mapping the spread rate of the different vegetation that is attainable in different areas.

A vegetation clearance detection sub-module can be used to prevent line sags and sways that can cause direct contact or flashovers that happen when electricity arcs from an energized line to nearby vegetation, allow distance between vegetation and power equipment since natural storms can fell trees or tree limbs onto lines, poles, and other electric equipment, and allow growth of vegetation so it does not form a direct path for electricity to travel to the ground. For scheduled maintenance trimming, the vegetation is typically trimmed along, below, and above power lines, thus removing tree limbs that are within 8 feet along the sides, 10 feet below, and 15 feet above the power lines. Clearance distances are mandated by Occupational Safety and Health Administration (OSHA) and vary with the voltage carried by the line. However, the process of vegetation management is usually manual, using land and air machines, and manual tools which is very time-consuming and expensive, up to billions of dollars annually. For the SL-PWR input data, depending on the level of threat posed by the distance between vegetation and equipment, the input data can be suitably labelled, such as 0.1 for normal distance and hence no threat, 0.5 for elevated threat level, i.e., the vegetation of the area should be managed as soon as the utility can, and 0.8 for extreme threat, where vegetation is in contact with power equipment whether vegetation-to-power equipment or vice versa in the case of sagging or downed lines and equipment, or according to the distance to the ground vegetation.

The power equipment module is active in the “Wildfire Analysis” and “Wildfire Progression” phase of the resilience trapezoid as illustrated in FIG. 3. During a wildfire analysis phase, the UAVs can inspect the transmission lines in high threat grids, along the travel path, for arcing/flashovers due to electrical faults. Lines can ignite/arc and remain in place after the actions of protective equipment, or can dissociate from the overhead poles and contact vegetation or ground to become an ignition source for a location with a high ignition potential. In the wildfire progression phase, it can be assumed that the equipment fire/flashovers come in contact with vegetation, that the line ejects combustible hot-metal particles to ground and starts ignitions in different locations, or the arcing remains continuous and provides a sustained source of ignition for a tangible amount of time. For example, high impedance (HiZ) faults occur in a sizeable number of faults when a single energized line conductor breaks and falls to earth but the resulting fault draws electrical current that is too small to blow a fuse or trip a circuit breaker due to surface contact resistance. Specifically, a line with HiZ fault can remain energized while it is on the ground for long periods of time which could be tens of minutes producing high-energy, high-temperature arcing. Conventionally, utilities rely on customer calls to detect this condition all while the line could still remain energized on the ground. Hence, the module can alert the operator on fault reclosing recommendations and as well inform the operator when the equipment risk has become a wildfire ignition.

This module can be integrated and trained with the wildfire module and modify the training network to output 6 classes which include “wildfire-fire,” “wildfire-smoke,” “wildfire-normal,”“equipment-fire,” “equipment-arc,” and “equipment-normal.” The module can differentiate between an equipment fire and an actual wildfire ignition, as this is very important information for utilities to be able to route appropriate resources accordingly. Additionally, the module can be trained to distinguish between equipment fire and arcing in order to adequately enable the operator take corrective actions to mitigate the fault. For instance, power line arcing can be caused by short-circuits which can result from damage/collapse of the poles/insulators/line structures, high winds which may cause conductor slap, an external conductive object (e.g., birds, wet objects) resting across live lines. On another note, equipment/power line fire can be caused by component contamination or failure in the equipment especially during prolonged dry periods. Component contamination can be as a result of a build-up of debris mixing with moisture to create conducting paths within components, which may lead to arcing and eventually equipment fires. Hence, distinguishing between these event types can aid in faster failure and fault forensics for the utility. Given the above, this module can also be applied in maintenance of power system equipment.

The wildfire module of the SL-PWR can include a fire and smoke detection sub-module and a fire localization and spread estimation sub-module. It can aid to detect ignitions, wildfires and under-surface fires, and to prepare utility crew routing to affected areas, as well as to identify extra gear requirements due to heavy smoke. The routing and gear requirements can be to schedule fire-fighting vehicles and equipment for those vehicles. Additionally, this module can inform the spread of the fire once ignited and burning, and can be active in the wildfire progression phase of the resilience trapezoid as illustrated in FIG. 3.

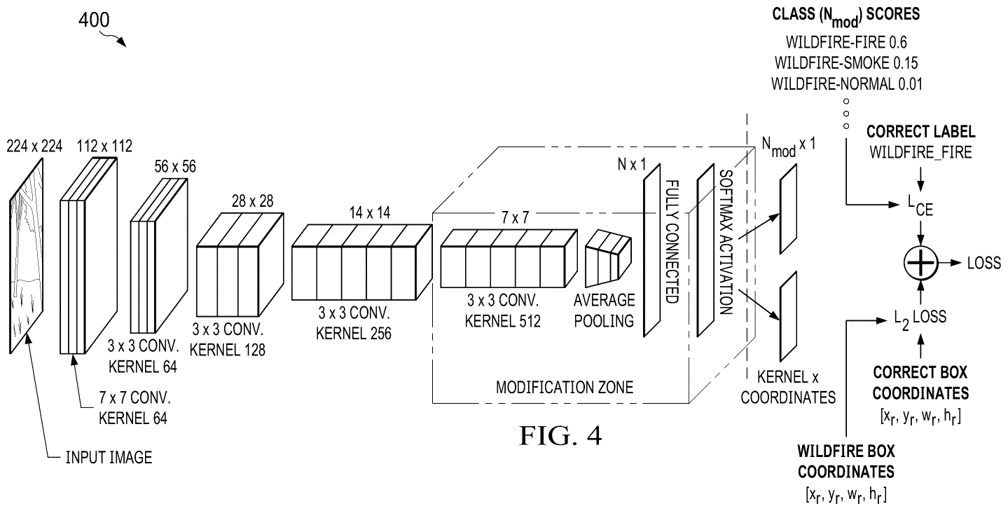

FIG. 4 is a diagram of a system 400 for a ResNet-18 architecture, in accordance with an example embodiment of the present disclosure. System 400 illustrates a modification zone for classification and wildfire localization problems. The wildfire fire-smoke detection sub-module can detect the ignition/occurrence of a wildfire. The grid being monitored could be in normal, smoke, or wildfire conditions, hence a multi-class approach can be used by adapting the ResNet-18 as in system 400. It can be co-trained with the power equipment fire-arc detection to improve robustness in distinguishing actual wildfire ignitions from fires/arcs captured on power equipment but have not yet caused an ignition.

The wildfire localization and spread estimation sub-Module is used to predict the wildfire boundaries using bounding boxes and then calculates the radial spread using the box coordinates. Hence, it can perform several main functions, such as localizing the wildfire in the grid and calculating a wildfire spread area. It can also enable calculating a rate of spread of the wildfire in real-time. The network architecture for this sub-module is described in Table 6.1. where the fully connected layer is modified to an input of 512 neurons with an output of 4 neurons which represent the wildfire bounding box coordinates to be detected. The 4 neurons indicate fire height hf, fire width wf, fire boundary positions on the x and y axis, xf and yf respectively, in a 2-dimensional grid, where the UAV captures the wildfire image from above the grid.

TABLE 6.1
The CNN training parameters of the localization and
spread estimation sub-module.

| Layer | Output Size | Spread Detection Model |
|---|---|---|
| Conv1 | 112 × 112 × 64 | 7 × 7, kernel 64, stride 2 |
| Conv2 | 56 × 56 × 64 | 3 × 3, max pooling, stride 2 |
| | | $[ \begin{matrix}3 \times 3 , 64 \\ 3 \times 3 , 64\end{matrix} ] \times 2$ |
| Conv3 | 28 × 28 × 128 | $[ \begin{matrix}3 \times 3 , 128 \\ 3 \times 3 , 128\end{matrix} ] \times 2$ |
| Conv4 | 14 × 14 × 256 | $[ \begin{matrix}3 \times 3 , 256 \\ 3 \times 3 , 256\end{matrix} ] \times 2$ |
| Conv5 | 7 × 7 × 512 | $[ \begin{matrix}3 \times 3 , 512 \\ 3 \times 3 , 512\end{matrix} ] \times 2$ |
| Average pool | 1 × 1 × 512 | 7 × 7 average pooling |
| Fully connected | 4 | 512 × 4 full connection |
| Softmax | 4 | |

This calculation can take into account the scale of the UAV image to the actual size of the grid at any height level at which the UAV captures the image, since this height influences the wildfire localization and spread calculation. Hereon, the localization model is developed assuming radial spread and hence an ellipse, as represented in (6.23), inside or outside the predicted bounding boxes.

$${Acc}_{2} = \frac{1}{N} {\sum }_{i = 1}^{N} \vert {𝓎}^{( i )} - {\hat{𝓎}}^{( i )} \vert \qquad ( 6.22 )$$

where x=a cos θ and y=b sin θ and the considered ellipse is centered at

$$( x + \frac{m}{2} , y + \frac{h}{2} )$$

where w and h are the height and width of the box, respectively. The ellipse external to the locus of
   the bounding box (i.e., the ellipse circumscribing the localization box) should be used when the bounding boxes are predicted conservatively, i.e., bounding box does not quite enclose fire area, then the area of the spread/ellipse should be assumed largest when sin 2θ=1. In the present disclosure, the box coordinates adequately enclose the wildfire location and hence the inscribed ellipse technique is utilized for fire spread as detailed below.

FIG. 6 is a diagram of a system 600 for calculating real-time wildfire spread and scaling to a grid area when UAV distance to ground level varies by the parameter “a,” in accordance with an example embodiment of the present disclosure. Let a−0=A and b−0=B in Fig. 6.6, then the area of the ellipse is:

$${A}_{ellipse} = π AB = π \times \frac{{h}_{box}}{2} \times \frac{{w}_{box}}{2} = \frac{π \times {h}_{box} \times {w}_{box}}{4} \qquad ( 6.26 )$$

Now assume that the box is the wildfire bounding box located in a captured grid which is a scaled version of the original grid, i.e., the UAV distance to ground level decreased during the capture of the image hence the captured image is magnified in comparison to the original image, as shown in system 600. The area of the wildfire spread can be calculated as follows. In order to find the scale of the wildfire bounding boxes, with height and width hf and wf respectively, to the original image, the following relationship is defined mathematically as:

$${Area}_{b \_ box} = \frac{( \frac{{w}_{f} \times {h}_{f}}{{h}^{2}} )}{{( \frac{original\_image \_length}{captured\_image \_length} )}^{2}} \qquad ( 6.27 )$$

where Areab_box is the scaled area of the wildfire bounding box with height and width wf and hf as illustrated in FIG. 6.

$${Area}_{b \_ box} = \frac{( \frac{{w}_{f} \times {h}_{f}}{{h}^{2}} )}{{( \frac{h + 2 a}{h} )}^{2}} \qquad ( 6.28 )$$

Then assuming radial spread, the spread area SArea is calculated as in (6.29).

$${S}_{Area} = \frac{( \frac{\frac{π {h}_{f} {w}_{f}}{4}}{{h}^{2}} )}{{( \frac{h + 2 a}{h} )}^{2}} \qquad ( 6.29 )$$

Furthermore, the fire localization and spread detection model can also inform the grid operator on the spread rate of the wildfire. In literature, mathematical models are developed in order to calculate wildfire spread rate, however, to improve situational awareness in utility operations, real-time monitoring is indispensable as spread rates are dynamic parameters which could be exacerbated or otherwise by weather conditions. These parameters such as spread rate can also be unique to certain geographical attributes not represented in the pre-defined mathematical models (e.g., spread rate according to topology/slope/land use of an area) hence making preexisting models inaccurate for real-time spread rate inference. Hence, the SL-PWR's wildfire localization and spread detection model in the wildfire module can aid to estimate the spread rate of the wildfires in real-time without any dependence on mathematical models, vegetation models, or quantitative data.

The spread rate can be obtained by getting the spread area of the fire at every time stamp that the UAV captures. The spread rate is then calculated by (6.30):

$${S}_{rate} = \frac{{S}_{{Area}^{i}}^{i} - {S}_{{Area}^{( i - 1 )}}^{i}}{{t}^{i} - {l}^{( t - 1 )}} \qquad ( 6.3 )$$

where S^{t}_{Area}^{t} and S^{t}_{Area}^{(t-1)} are the farthest point towards the direction of wildfire spread at time t and t−1, respectively.

The burnt equipment detection and estimation module is active in the restoration phase of the resilience trapezoid post wildfire occurrence. After the wildfire is suppressed, the power grid equipment in the area will most likely suffer some damages and burns depending on the amount of time the fire-fighting crew spent to curtail the fire. Conventionally, power utilities would route supervisory crews to different areas of the burnt grids to inspect the level of equipment damage towards an estimation of restoration costs. This technique would increase not just the cost of damage estimation but also time to infrastructural restoration of the system. With the burnt equipment detection and estimation module, the UAVs can monitor the status of equipment providing the type and level of burn damage towards a more economic and transparent approach to cost estimation. A major advantage of this module is that it comes with actual equipment images and provides a high level of transparency in cost estimation. The architecture of this sub-module consists the detection and estimation parts. The detection part is a classification model that aims to differentiate between the main types of damages to the power equipment after wildfires occur which are 1) the burning/damage of the top/cross arm area of the power pole; 2) the burning of the base of the power pole; and 3) the leaning of the power pole structure from the axis of the normal. In this case, the detection network is basically as described in Table 6.1, however, with the fully-connected and Softmax layers having 3 neurons respectively.

The estimation network for each of these types of damage then consists of a series of convolutional layers which take as input, positively classified images and culminate towards predicting a scalar that informs the extent of burn damage. The architecture of this sub-module is described in Table. 6.8, where the layer 5 of the convolution is modified from 512 channels to 1 channel, and then the 14×14 average pooling is performed which then yields the scalar value representing the burn damage estimation of the input image. The labelling of the input image ground truth takes certain logic for different burn damage scenarios.

TABLE 6.8
The CNN architecture and parameters of the Burned
Equipment Detection/Estimation training module.

| Laver | Quipot Size | Spread Detection Model |
|---|---|---|
| Conv1 | 112 × 112 × 64 | 7 × 7, kernel 64, stride 2 |
| Conv2 | 56 × 56 × 64 | 3 × 3, max pooling, stride 2 |
| | | $[ \begin{matrix}3 \times 3 , 64 \\ 3 \times 3 , 64\end{matrix} ] \times 2$ |
| Conv3 | 28 × 28 × 128 | $[ \begin{matrix}3 \times 3 , 128 \\ 3 \times 3 , 128\end{matrix} ] \times 2$ |
| Conv4 | 14 × 14 × 256 | $[ \begin{matrix}3 \times 3 , 256 \\ 3 \times 3 , 256\end{matrix} ] \times 2$ |
| Conv5 | 14 × 14 × 1 | 3 × 3, kernel 1 |
| Average pool | 1 × 1 | 14 × 14 average pooling |

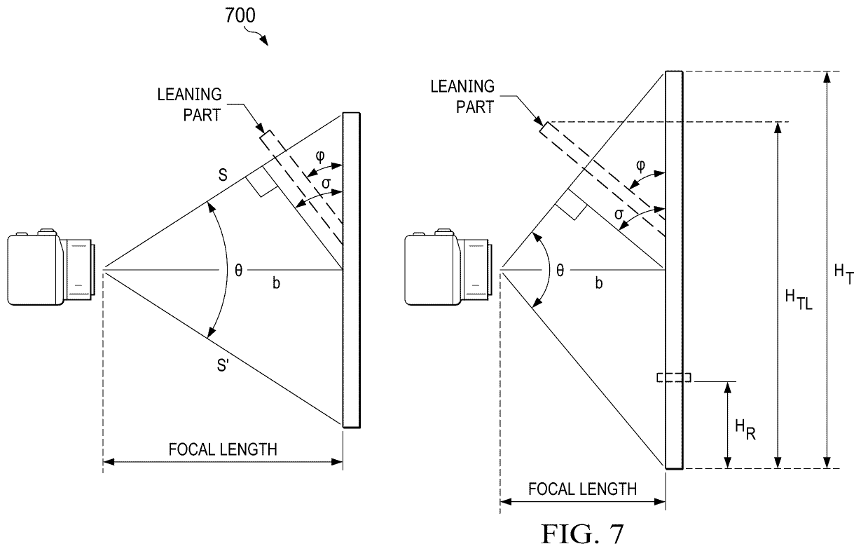

FIG. 7 is a diagram of a system 700 for restoration estimation for damaged poles, in accordance with an example embodiment of the present disclosure. Calculating the parameters of poles affected by burning can be performed to obtain accurate electric equipment parameters after a wildfire/burning/arcing incident. After the incident occurs, the UAV arrives and takes images of the power system equipment. However, there can be a need to map the height parameters of the captured image with the real equipment parameters, as shown in system 700. In order to do this, reference heights for electric poles can be used, where references will be any object/mark of a known height. For instance, the reference could be the pole tags which are already widely employed by power utilities. The pole height can be calculated as:

$${H}_{T} = ( \frac{{H}_{T}^{P}}{{H}_{R}^{p}} ) {H}_{R} \qquad ( 6.31 )$$

where HT is the actual height of the electric equipment, Hp is the measured height of the electric equipment in the captured image/picture, HR is the actual height of the reference, and Hp is the measured height of the reference object in the captured image/picture. The normal image of the equipment for which HT is calculated can be used as a permanent documentation of the height measurement of the equipment in question and or similar equipment. For the three common scenarios being considered, estimation are as follows:

### Scenario 1—Bolted-on Base:

$${H}_{bolted} = [ ( \frac{{H}_{T}^{p}}{{H}_{R}^{p}} ) {H}_{R} - ( \frac{{H}_{{T}_{burnt}}^{p}}{{H}_{R}^{p}} ) {H}_{R} ] + L \qquad ( 6.32 )$$

where Hbolted is the estimated height of the burnt base to be bolted-on, Hp is the measured height of the remaining top part of the equipment from the captured image, and L is the total of the margin of error plus the part of the pole that goes underground for the foundation of the equipment.

### Scenario 2—Leaning Pole:

$${H}_{D} = {H}_{T} - {H}_{TL} = [ ( \frac{{H}_{T}^{p}}{{H}_{R}^{p}} ) {H}_{R} - ( \frac{{H}_{{T}_{leaning}}^{p}}{{H}_{R}^{p}} ) {H}_{R} ] \qquad ( 6.33 )$$

where Hₜ_{_{leaning}}_{^{φ}} is the measured height of the leaning power equipment in the captured image.
   Furthermore, the angle of lean/angle of tilt φ can either be estimated directly from the image or can be calculated more accurately albeit more rigorous, as follows:

φ=σ (6.34)

where σ is the angle made by the line parallel to the leaning part of the pole at the baseline with length b and perpendicular to the slope with distance s, θ is the angle of view of the camera mounted on the UAV and is calculated as follows:

$$θ = 2 \times arctan ( \frac{{S}_{W}}{2 \times {F}_{L}} ) ( 180 / pi ) \qquad ( 6.35 )$$

where SW is the sensor width also known as the width of the camera film (these are standard for different camera types), FL is the focal length of the camera lenses, and (180/pi) aids the conversion between degrees and radians. In practice, it may become problematic to position the UAV in such a way as to obtain the line which is parallel to the leaning part and perpendicular to the slope in order to calculate the angle σ as 90°−(90°−θ, hence close approximations can be made by “eye-balling” the images.

### Scenario 3—Attached Cross-Arm Extension

$${H}_{cross - arm} = [ ( \frac{{H}_{T}^{p}}{{H}_{R}^{p}} ) {H}_{R} - ( \frac{{H}_{{T}_{base}}^{p}}{{H}_{R}^{p}} ) {H}_{R} ] + e \qquad ( 6.36 )$$

where H_{T}_{_{base}}^{p} is the measured height of the remaining unburnt part of the power equipment. Here, the parameter L is eliminated since the margin of error can easily be compensated for using c and there is no need for estimating the height of the equipment to be buried towards the equipment foundation.

Optimization of system UAV resources can be used to mitigate both endogenous and exogenous wildfires before they occur, or manage these fires in real-time, if they occur. The SL-PWR utilizes potential ignitions pre-wildfire in order to prepare for critical scenarios and proceed with optimal strategies to better respond to and mitigate risks arising from extreme wildfire events including the propensity of outages caused by exogenous wildfires and power shutoff to customers as a result of wildfire threat (de-energization to prevent endogenous/power equipment-caused wildfire).

FIG. 8 is a diagram of a system 800 for UAV resource optimization, in accordance with an example embodiment of the present disclosure. The UAV system of the SL-PWR can obtain images of geographical locations of interest in terms of power equipment, vegetation, and potential ignition locations towards preventing both endogenous and exogenous wildfires. In order to obtain the input images, the UAV flies over the geographical area under consideration taking in GPS navigation enabled by the potential ignition probability maps produced by the STWIP model. First the STWIP can send in all the i.loc with normal-elevated-extreme levels of wildfire threat, where normal threat level locations (i.loc) has probability ≤0.5, elevated threat level i.loc have 0.5≤probability ≥0.8 and extreme threat level i.loc have probability ≥0.8. Since the forecasted threat locations in the potential ignition probability map have a “cluster-like” attribute, i.e., if an i.loc is of extreme threat level then there is a high probability that surrounding grid points have the same threat level, the UAVs can be stationed in the center (gc.loc) of the grid with the cluster under consideration. The resource information can be collected as illustrated in system, 800, where the potential ignition map from STWIP is as furnished where grids G1 and G5 have the extreme and elevated threat levels respectively, and V gi is the vegetation type (crown V g1, grass V g2, litter V g3) associated with the grids. Furthermore, PEi is the amount of power equipment associated with the grids, for instance, PE1 has a higher criticality (weight) in terms of power equipment since it has more 4 lines, a generator and 3 buses, than PE2 with 4 lines and 2 buses, and PE3 with 2 lines and 2 buses, assuming the loads served in each area are equal i.e., L1=L2+L3=L4+L5. Additionally, PEi factors in the “Power Equipment Age” and “Fault Frequency” of the equipment in the said grids.

If the goal is to route UAV 1 to grid G1 to monitor the extreme threat for the length of time the threat is viable, then in order to get to G1, UAV 1 travels along a path, and since the UAVs are limited resources, the operator wants to maximize the monitoring of critical grids without compromising with the risk posed by G1. Towards this aim, a weighting/criticality factor is also assigned to the grids (G1-G9) depending on the threat level in the potential ignition maps i.e., criticality of G1≥criticality of G5≥criticality of (G2-G4, G6-G9). A sample optimal route would be {G8-G5-G1} because in G8 there exists crown vegetation and higher amount of power equipment, increasing the likelihood of there being tall encroaching vegetation towards power lines. In G5 there are also 4 power lines with grass vegetation making the rate of spread of fires rapid if power lines sag or fall to the ground. Thus the SL-PWR will obtain more crucial and targeted information via this path as opposed to {G3-G2-G1} which has a lower number of power lines and with litter vegetation which does not pose as much threat in a wildfire scenario.

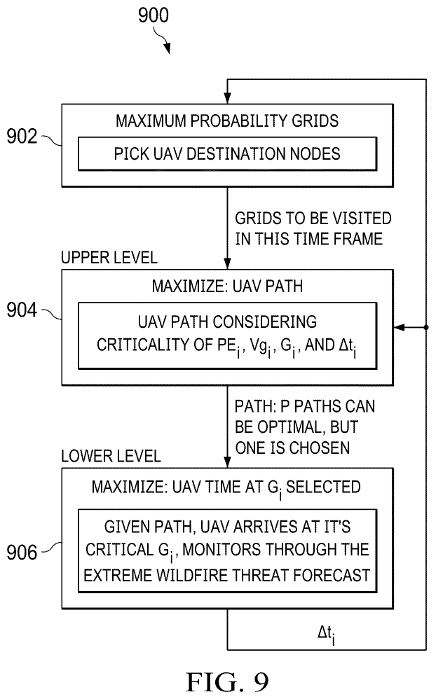

FIG. 9 is a diagram of a system 900 for UAV resource optimization, in accordance with an example embodiment of the present disclosure. Maximum probability grids 902 are picked from the potential ignition probability map from STWIP and these become the monitoring destination of the UAVs. However, the path of the UAV to the destination grid is optimized in order to utilize limited UAV resources more efficiently.

Note that the grid centers are assumed equidistant since the UAVs are airborne and can fly directly to grid centers as opposed to land mobiles that have to go through a road network. Hence, the optimization proposed in this section is to capture the routing of UAV resources since these resources can be limited in availability due to cost of purchase (dollar cost) or cost of operation (computational and dollar cost of training and transport). The UAV routing problem is a bi-level one illustrated in system 900 and formulated as follows.

The upper level determines the UAV path by maximizing the criticality across the PE, V g, and G layers of the geographical area as illustrated in FIG. 8. In (6.37), the objective is to maximize the criticality of the grids towards optimizing the travel path of the UAV as it moves along to its destination grid.

$$max {\sum }_{i ∈ path} {PE}_{i} \cdot V gi \cdot {Cr}_{i} \cdot Δ {t}_{i} \qquad ( 6.37 )$$

The equation 6.37 can be used by maximize UAV path 904 to determine the maximized path={p1, p2, . . . , pN}, ∀ UAV={1, 2, . . . , J} where PEi is the information of power lines (amount/density, age, fault frequency) in the grid i, V gi is the growth rate of vegetation predominant in i, Cri is the criticality of potential ignition in i (normal, elevated and extreme probability grids), and Δti is the amount of time since the grid was last visited by a UAV. Hence, (6.37) can be used to choose the optimal UAV paths given that high vegetation growth areas are quickly able to encroach power lines and need to be visited often. As well, grids with high power equipment density are more likely to cause endogenous wildfires than lower density grids. The criticality of the grids ensures that even elevated wildfire threat grids can also be visited even if not as oven as the extreme grids. This is because wildfires can occur outside the predicted extreme area as was the case with the famous Campfire. Lastly, Δti ensures that grids of sufficient criticality are not overlooked for too long and are visited occasionally.

For UAV-resource constraints:

$${\sum }_{i = 1}^{N} {p}_{i}^{d} \leq {s}_{UAV} \cdot {t}_{UAV}^{charge} ∀ UAV \qquad ( 6.38 )$$

where N is the number of grids in the chosen path, sUAV is the travel speed of the UAV, tcharge is the time the UAV charge will last, and pd is the distance it takes to get to grid i from the preceding grid i−1 in the path assuming equidistant grid centers, since the UAVs fly and there is a straight line of flight between the gc.loc of adjacent grids i−1 and i in the path. This constraint ensures that the UAV path is feasible in terms of the time of travel afforded by the UAV's charge state. Further weeding out of infeasible paths can be done with high-fog/high storm grids. The output of this level is a set of selected paths PUAV={p1, p2, . . . , pN} for every UAV.

The lower level problem is a maximum UAV monitoring coverage one taking in the output of the upper level, PUAV={p1, p2, . . . , pN}. In each path pi, there are grids from i={1, . . . , I} The UAV optimization has to ensure that the UAV does not spend undue and valuable time monitoring/flying through the paths (I−1) leading to the assigned destination grid I. This level ensures that the UAV-assigned extreme threat grid gets maximum monitoring coverage in and within the appropriate time.

$$max {\sum }_{{p}_{i} ∈ {P}_{UAV}} {y}_{j} \cdot {τ}_{j}^{I} \cdot {Cr}_{sum}^{{p}_{i}} ∀ UAV \qquad ( 6.39 )$$

$${\sum }^{{P}_{UVA}} {y}_{j} \leq 1 \qquad ( 6.4 )$$

$${τ}_{j}^{I - 1} \leq {T}_{s}^{I} \qquad ( 6.41 )$$

$${τ}_{j}^{I} \geq {T}_{e}^{I} - {T}_{s}^{I} \qquad ( 6.42 )$$

Equation 6.39 can be used to determine that within the selected paths, the paths with higher criticality is maximized while ensuring that the most time within the UAV travel time is spent monitoring the assigned destination grid I which is the last grid in the selected path, where yj is a binary variable that indicates if a path is selected (yj=1) for UAV j or not, τI is the amount of time spent at I by UAV j, and Crpi is the criticality of the path i.e., weight of all grid nodes in the path. In (6.40), the aim is to ensure that for each UAV, no more than a path is selected for travel to its destination node I, however, once the UAV arrives at that destination it can still add another route to its trip if the feasibility constraints allow, (6.41) ensures that the travel time through the path just before the UAV arrives at I is less than the predicted start time of the wildfire threat T I, and (6.42) ensures that the UAV keeps monitoring I for the duration of the wildfire threat, where T I is the end time of the wildfire threat i.e., the time until which the wildfire threat is viable.

For the UAV optimization process, a graph-theoretic algorithm is disclosed. A three-step procedure can be used to determine the optimal UAV monitoring strategy:
1) build the UAV monitoring trees forming UAV paths based on grid criticality,
2) path selection and
3) solve for maximum monitoring coverage at I.
   In the first step, the paths from the UAVs to the extreme wildfire threat grids are identified. Hence, each UAV could have more than one monitoring path forming a monitoring tree with all paths starting from that UAV as the root node. In the second step the path selection is carried out limiting the set of paths to feasible paths through which the UAV could travel and considering the UAV charge capacity. The third step takes care of the maximum monitoring coverage of the UAV over the assigned high wildfire risk grid. In this step, it is ensured that the UAV flies through the most critical path while not spending crucial time on the path of travel and spends the optimal time monitoring it's assigned grid. This is achieved by maximize UAV time at g 906 to ensure the UAV time spent at its assigned grid is maximized while making sure the time spent in the travel path does not exceed the start time of the wildfire risk forecast and that the UAV monitors the high risk grid till the end of the high risk forecast.

Building the monitoring trees is performed as follows. The geographical area is modeled as an undirected graph G=(V, E) with different layers, including the potential ignition map, the vegetation layer and the power equipment layer. The set of nodes V represent the grid centers that carry the grid attributes through these different layers. The set of edges E represent the inter-grid UAV flight path which is assumed to be an equidistant and direct line of flight. Additionally, a source node is the node from which a UAV takes off while a destination node is the critical high risk node to which a UAV has been assigned to monitor. Each node has a weight w whose value is set to the combined criticality of the grid across all its layers, and each path has a weight Crpi, which is the sum of criticality of the nodes on the path. The UAV-monitoring path is the path with the highest criticality/weight that gets to the destination node within the critical time. A modified Dijkstra's algorithm is used to obtain the paths from the UAV source node to the assigned destination node to form the monitoring tree and via pruning the tree, infeasible paths are eliminated. The pseudo code for the building the UAV monitoring tree is as illustrated in Algorithm 5. From the algorithm, the UAV monitoring paths are returned as a tree whose root node is sourced from s. Furthermore, for a node v∈V, v.dist is the distance from s to v which is the weight/criticality Crpv of the nodes in the monitoring path from s to v, and v.dist will be updated to equal the weight of the monitoring path when a monitoring path is found. The criticality of each grid is adjusted to M−Crtot* in order to maintain the shortest path attribute of the algorithm since our objective is to maximize the weight of the chosen path and the Dijkstra's algorithm does not work well with negative weights, where M is a fixed number bigger than Crtot* across all UAVs. Additionally, v.path is the set that will contain the predecessors of v forming individual paths which are then appended to v.trip. A priority sequence S is used to store nodes that have not been explored by the algorithm and also to manage the nodes which form key-value pairs with the node's distance. The nodes are explored by extracting from S, the node with the minimum distance and adding such a node to the v.path for that UAV which should run from its source node to the assigned destination if a path exists.

Algorithm 5 Building the UAV Monitoring Tree

| | |
|---|---|
| 1: | [symbol] Initialization of parameters |
| 2: | for node v ∈ V do |
| 3: | v.dist ← ∞ |
| 4: | v.path ← { } |
| 5: | v.trip ← { } |
| 6: | v.trips ← { } |
| 7: | D* ← { } |
| 8: | M ← big number |
| 9: | end for |
| 10: | s.dist ← 0 |
| 11: | S ← V |
| 12: | D ← Set of UAV destination nodes |
| 13: | T ← Set of wildfire threat start time of elements of D |
| 14: | [symbol] Obtain UAV monitoring paths |
| 15: | while D ≠ ∅ do |
| 16: | q ← EXTRACT-MIN-DIST(S) |
| 17: | for node v ∈ adjacent to q do |
| 18: | [symbol] Modified Dijkstra relaxation operation |
| 19: | Cr [symbol] = PE [symbol] · Vgi · Cr [symbol] · Δt [symbol] |
| 20: | Cr [symbol] = M−Cr [symbol] |
| 21: | if v.dist ≥ q.dist + Cr [symbol] then |
| 22: | v.dist ← q.dist + Cr [symbol] |
| 23: | v.path ← q |
| 24: | end if |
| 25: | end for |
| 26: | if q ∈ D then |
| 27: | D ← D − [q] |
| 28: | v.trip ← v.path |
| 29: | v.path ← ∅ |
| 30: | end if |
| 31: | if S = ∅ then |
| 32: | D* ← q |
| 33: | v.trips ← v.trip |
| 34: | v.trip ← ∅ |
| 35: | S ← V |
| 36: | end if |
| 37: | end while |
| 38: | [symbol] Build the UAV monitoring tree |
| 39: | Vₜᵣₑₑ ← {s} |
| 40: | Eₜᵣₑₑ ← ∅ |
| 41: | for destination node v ∈ D* do |
| 42: | Check the monitoring trip feasibility from s to v |
| 43: | Feasibility based on the UAV flight range, weather |
| | conditions, and travel time. |
| 44: | Travel time is before threat start time forecast in T |
| 45: | if monitoring path is feasible from s to v then |
| 46: | [symbol] Add nodes to monitoring path, v to Vₜᵣₑₑ, |
| | and add edges to Eₜᵣₑₑ |
| 47: | [symbol] Drop extra paths if any, leaving one |
| | feasible path in v.paths |
| 48: | while v ∉ Vₜᵣₑₑ do |
| 49: | Vₜᵣₑₑ ← Vₜᵣₑₑ ∪ {v} |
| 50: | Eₜᵣₑₑ ← Eₜᵣₑₑ ∪ {v trips[v], v} |
| 51: | v ← v.trips[v] |
| 52: | end while |
| 53: | end if |
| 54: | end for |
| 55: | [symbol] Return |
| 56: | Tree ← (Vₜᵣₑₑ, Eₜᵣₑₑ) =0 |

[symbol]

indicates data missing or illegible when filed

Lines 2-10 initialize the parameters for the nodes towards implementing the modified Dijkstra's relaxation operation where distance value (dist) of all nodes are set to infinity while the source node's is set to 0 (Line 10). For each v, the v.path is a null set where the predecessors q of v are appended. In Line 8, a fixed number, M, bigger than Crtot* across all UAVs is defined in order to maintain the minimum distance attribute of the Dijkstra's shortest path. In line 11, all nodes (grid centers) are inserted into the sequence S, the set of destination nodes D is defined in line 10, while the set of predicted potential wildfire risk start time in each of the grids T is defined in line 13. Since the distance from adjacent grid centers are equidistant, the time taken to travel a path can be easily obtained given the speed of the UAV. In the while loop of lines 15-37, a modified Dijkstra's algorithm is utilized to find the UAV monitoring paths to the destination node. Here, for each destination node, the node q, with the minimum distance (in the first iteration, this is the source node with s.dist=0), is extracted from S and explored. After extracting q, the relaxation operation is applied to the nodes adjacent to q as seen in lines 17-25, and it is removed from S. For the path with the maximum criticality for the UAV, the fixed number M can be used, for which Crtot must be positive across all UAVs. If q is a destination node, then a monitoring path is found for that destination node and q is removed from the set of destination nodes (lines 26-27), v.path is appended to v.trip (line 28) while the UAV moves along to another destination node in the same trip if feasible. This ensures that in a UAV trip it could be able to get to more than one destination node if possible. This is enabled by lines 31-36, the node set in G is appended back to S if the sequence becomes empty before D becomes empty (signifying the end of a trip). This ensures that each destination node is explored and reached once if a path exists, and while all destination nodes have not been explored but S is empty, the UAV monitoring path is renewed from s to form several other paths (and possibly trips) to explore the destination nodes that have not been explored. In line 32, the elements of set D* are the leaf nodes of each UAV tree.

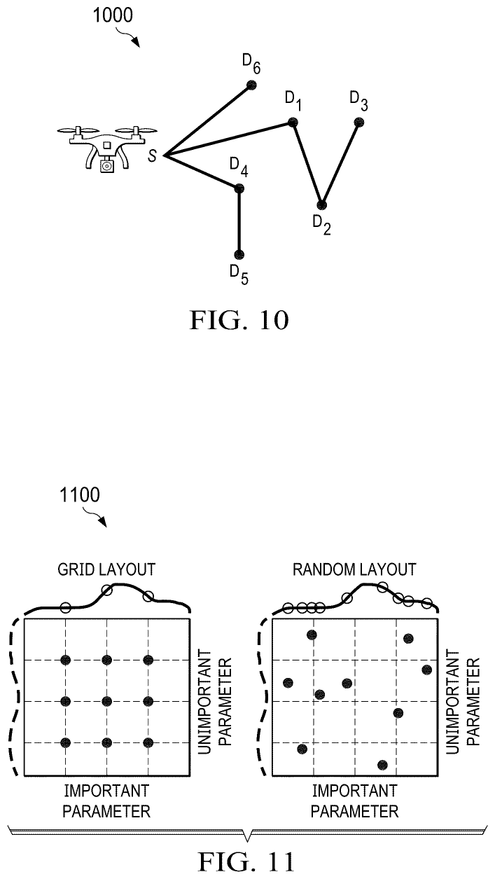

FIG. 10 is a diagram 1000 of a UAV trip with destination nodes {D1, D2, D3, D4, D5, D6}, in accordance with an example embodiment of the present disclosure. The first total travel path (a trip) for the UAV may contain the paths to allow the UAV to intersect with {D1, D2, D3} before the set S goes empty, then the set S is replenished with V to make another trip which may contain {D4, D5} before the set S goes empty, then again S is replenished with V to make a trip to {D6}. This is more efficient as the UAV trip covers more destination nodes in one trip, as opposed to returning to the source after reaching one destination.

The search for the monitoring path ends when either of the all destination nodes have been explored if path found (D=0) or otherwise e.g., when there is an obstacle such as storm that prevents the UAV from traveling through a grid. Lines 38-53 build the UAV monitoring tree, where a feasible trip is chosen for each UAV from source node s to destination node ∈D*. The graph Tree which is made up of (Vtree, Etree) represents the UAV monitoring tree where Vtree is the set of nodes of the tree, and Etree is the tree's edge set, not including infeasible paths or dropped trips.

These modules of the SL-PWR were evaluated using well performing hyper-parameters, for instance, learning rates are tested in powers of 10 as optimizing the hyper-parameters are better in log space. Moreover, the evaluation established that data collection and processing was successful using search engines to gather relevant images which serve as substitute to the UAV captured images. Input data post screening consisted of >1800 images including 863 images of which 307 vegetation type images consisting of 55.43% of crown vegetation, 28.80% of grass vegetation, and 15.75% of litter vegetation types. Additionally, there are 283 vegetation distance dataset images and 125 images for fire spread prediction, and 286 images for the burnt detection and estimation module with Leaning: 27.33%, Bolted_base: 36.63%, Extended_crossarm: 36.05%. The images were resized to 224×224 with RGB color channels to rhyme with the input requirements of the base ResNet model, and were color normalized. Color normalization aids the emulation of different times of day in which the UAV will capture images for the SL-PWR, using contrast from 0-255 for minimum to maximum intensity pixels. For all modules, the database was split to training, validation and test datasets which have three major data augmentations including five-crop, random flipping and color jittering. Prior to the five-crop, the images are padded and resized to 235×235 and the images are cropped at the four image edges and at the image center to a final 224×224 size.

FIG. 11 is a diagram 1100 showing random search hyper-parameter optimization to ensure that more of the hyper-parameter space is visited while training the CNNs, in accordance with an example embodiment of the present disclosure. The hyper-parameters such as the learning rate are set after cross-validation where, using a random layout technique, such that distinct values of the function are visited during the hyper-parameter optimization as illustrated in diagram 1100. Different learning rates were trained over epochs and validated, where the hyper-parameter with the best validation result was chosen. The training hyper-parameters were then fixed while a batch size of 64 images were used, with Adam optimizer and 25 training epochs using the TensorFlow framework and Google Colaboratory using designated GPU runtime. The modules are trained and validated individually except for the wildfire module and the power equipment module which is intentionally trained together so that the SL-PWR could be sensitive to an equipment fire vs. an ignited and flaming wildfire. The model, summarized in Table 6.2, which shows “Very Early Detection” of less than 40 milliseconds once the UAV images are captured. This “Very Early Detection” can be used for fire-fighting when every second matters. For all the modules, the dataset was split into 6 for training data, 2 for validation data, and 2 for test data.

TABLE 6.2
Parameters of the SL-PWR.

| | | | | | | Image |
|---|---|---|---|---|---|---|
| | | Learnable | Train. And | | Train&Eval. | prediction time |
| Module | Sub-modules | params. | Eval. Samples | Epochs | time (sec.) | (sec./image) |
| Vegetation | Type Detector | 11178051 | 245 | 25 | 222.18 | 0.139188909 |
| | Clearance Estimator | 2783041 | 227 | 100 | 188.05 | 0.181152294 |
| Power Equipment | Type Detector | 11179590 | 690 | 25 | 608.75 | 0.067470726 |
| Wildfire | Fire-Smoke Detector | | | | | |
| | Spread Estimator | 2783041 | 100 | 100 | 170.07 | 0.027984476 |
| | Localization Estimator | 11178564 | 100 | 200 | 391.07 | 0.035381708 |
| Burnt-Equipment | Damage Type Detector | 11178051 | 230 | 150 | 778.13 | 0.16672171 |
| | Damage Estimator | 2783041 | 230 | 100 | 492.25 | 0.028728008 |

The vegetation module consists of the base CNNs which are trained towards detecting the vegetation types and the vegetation clearance distance towards the utility vegetation management. The input dataset of the first CNN consists of all images from the 3 different classes for vegetation types namely: grass, crown and litter, while the output consisted of the classification of the input image into one of these 3 umbrellas. In training this network, the Adam optimizer is used with a learning rate of 5×10-5, while a batch of 64 images is trained over 25 epochs. The sub-module performance provided validation accuracy up to 93.4% and test accuracy against the unseen part of the dataset was 91.8%. The variation of the cross entropy loss function over different epochs in the training and validation of the network was observed, showing great improvement as the training epochs progressed.

The second network in this module estimated the vegetation clearance distance, taking an input of images and outputting a scalar value of the level of clearance of vegetation from the power equipment. The level of clearance was on a scale of (extreme=0.1, elevated=0.5, normal=0.8) depending on the closeness of the vegetation to the power lines. The parameters such as the optimizer used is similar to the previous network, however, the learning rate is 2×10−5, with the batch size reduced to 32 while the number of epochs is increased to 100 in order to further facilitate learning.

The power equipment module was co-trained with the wildfire fire-smoke detection in order to further learn the different fire types (“equipment fire,” “wildfire fire”) and also the similar incidents such as equipment arcing. The Adam optimizer was also used with a learning rate of 5×10−5 and a batch size of 64 images trained over 25 epochs. The performance of the module was as visualized in Fig. 6.18, with the performance of the module on unseen images i.e., the test data prediction accuracy as 89.60%.

The incorrect predictions of the module can be used to understand how to better improve the network. It can be seen that the network generally performs relatively worse when the data augmentation is darker, i.e., simulating night time. For instance, at night time, the module was stumped on the difference between an equipment arcing and an equipment fire, because both are bright reddish at night time. On a similar note, with the data augmentation emulating sunrise in the third image, the brightness of the sun angle was seemingly confused for an arcing incident down the line of sight of the poles. In a fourth image, there was both fire and smoke in the image and since the night time shadows the smoke, the equipment fire is more visible. This data highlights the need for using night vision cameras with the UAVs, as well as for the system operator to consider why the SL-PWR would be raising an incident alarm by looking at the captured image in particular. Incorrect predictions can be improved or even mitigated with more training data samples of these incident types.

The wildfire module can include a wildfire fire-smoke detector, spread estimation and a fire localization model. The wildfire fire-smoke detector can be co-trained with the power equipment module as discussed earlier. The spread estimation can evaluate the spread of the fire in the “g×g” km grid cell that the UAV is monitoring according to (6.29), while the localization model can identify the location of the fire in the monitored grid cell. These sub-modules are further discussed as follows.

For the wildfire fire-smoke detection module, since this module can be co-trained with the equipment module, the same parameters can apply with the training of the network. The incorrect predictions of the network relative to the wildfire fire-smoke detection can be seen to be challenging during the night time also, where the darkness masks the smoke and hence the network is only able to detect the fire.

Moreover, the prediction accuracy was determined to differ for individual classes predicted by the wildfire-equipment type network. The network was 100% able to detect the normal conditions, leaving little to no chance of a false positive. With the wildfire fire and smoke, the network's performance was >90%, while the equipment fire was a little short of 90% prediction accuracy. The least prediction accuracy was the equipment arcing with performance at about 75%. This performance can be improved by increasing the number of input samples fed into the network, as the equipment arcing example were only 7% of the tested input data.

For the wildfire localization and spread estimation module, the wildfire spread can be calculated and labeled as discussed in (6.29). The network can be trained with the Adam optimizer, with a learning rate of 2×10−5 and a batch size of 32, over 100 epochs. The performance of the spread estimator showed the MAE and MSE reduction with the training epochs, while the average MSE for the test data was 0.01166.

For the localization estimator which locates the fire on the grid cell being monitored, the fire position in the x and y axis and the height and width of the fire around its boundaries is needed. The localization estimator can then predict the 4 parameters in order to locate the fire on the monitored grid. The tested network was trained with Adam optimizer, minimizing over the MSE loss (regression model), with a learning rate of 1×10−3 and a batch size of 64, over 200 epochs. The performance of the model with respect to the loss minimization (MAE and MSE) was determined, while the average pixel deviation recorded by the MSE on the test data was 42.09. Furthermore, the predictions of the localization estimator were visualized to see sample deviations between the ground truth and the predicted location.

For the burnt equipment detection and estimation module, equations 6.31, 6.32, 6.33, 6.35 and 6.36 are used to calculate the inputs. However, because there is no available database of actual utility pole images (with reference heights HR, Hp etc.) and the SL-PWR images are mostly sought from search engines, realistic assumptions were used to test the module based on current utility practices in the United States in image labelling as follows.

In order to label the image data input, it was assumed that all pole heights are 12 m long as in the United States the standard electric power utility pole is on average 12 m long and buried often 2 m in the ground. This information was used in order to label the image data. It was also assumed that the length of all poles is 12 m, however, for scenario 1 (bolted-on base), the 2 m pole-burying height was also considered.

$${L}_{estimate} = \frac{n \times ( 12 m / 14 m )}{h} \qquad ( 6.43 )$$

where Lestimate is the length of the burnt off part of the pole, n is the length of the burnt off part of the pole in the image with respect to the ground, h is the height of the entire pole in the image with respect to the ground, and 14 m is used for estimating in scenario 1 (bolted-on base) as the 2 m pole-burying height is also considered, as opposed to the scenario 3 (attached cross-arm sets the standards for construction and maintenance of utility poles extension). The angle of tilt/lean of the electric poles are also measured in the input image labeling as the images obtained from search engines do not have any standard position/height/angle of capture. While training the model, the risk of overfitting was quite high due to the dearth of training image data (burnt and leaning power poles with missing base and cross-arms). In order to reduce the overfitting, additional data augmentation was integrated, including Image flipping, gray scaling on all 3 channels, and color jittering with brightness=0.2, contrast=0.2, saturation=0.2, hue=0.2. The Random Affine transformation is also used in order to preserve points, straight lines, and planes where parallel lines remain parallel after an affine transformation, hence aiding to correct for geometric distortions or deformations that occur with non-ideal camera angles. However, obtaining more image input for training the module will improve its performance substantially.

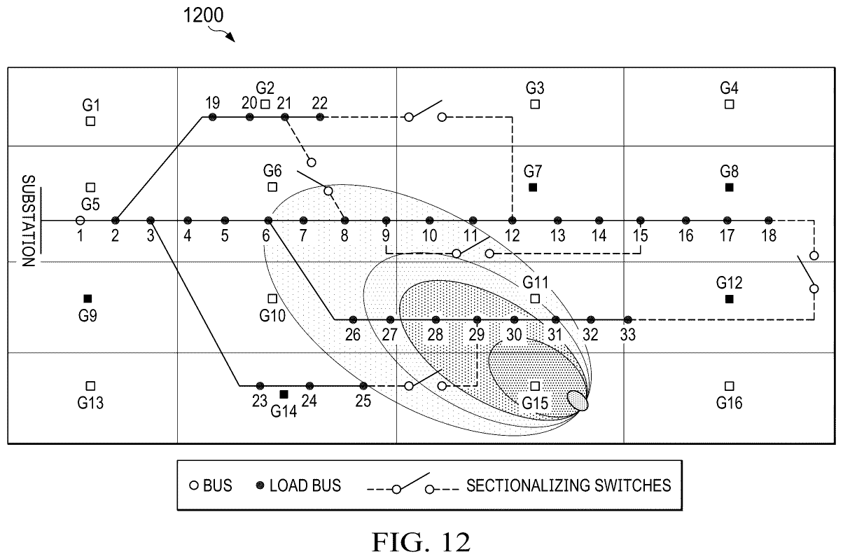

FIG. 12 is a diagram of a UAV monitoring system 1200 of the SL-PWR spatially and temporally optimizes routing to high wildfire threat grids, in accordance with an example embodiment of the present disclosure. For UAV optimization a gridded area which consists of 16-grid cells was superimposed on the standard IEEE 33-bus test system to test the UAV optimization process and monitoring trees in order to validate the effectiveness of the disclosed systems and methods. The one-line diagram of the test system is shown in UAV monitoring system 1200. The layer 1, layer 2, and layer 3 weights were chosen off a random distribution [0,1] for the different grids, Δti was assumed to be 1 ((t1−t0)=(1 0)) since the first optimization time step was illustrated, while M was chosen to be 1. The same graph structure was used for the modified Dijkstra's relaxation to get the UAV tree, and then the graph attributes were modified to inter-grid travel time, to select feasible UAV trips. For adjacent grids, the travel time was 1, while for diagonal grids, the travel time was 1.41. The trip feasibility based on the travel time of the paths which make up the trip, is informed by forecasted threat start time that STWIP or any utility prediction technique indicates a wildfire threat. From this time, if that grid is exposed to an ignition source, a wildfire can be sustained. Hence, the UAV must arrive at the grid on/before this time. Monitoring time was selected based on the wildfire threat in a grid being viable, and hence the UAV must monitor this grid for this threat duration before routing to another destination if feasible in the same trip.

Two scenarios were studied to generate the data in Tables 6.4 and 6.5: a) The Lax case, where monitoring time is an estimate, e.g., extreme threat expected from noon to within 5-7 pm when temperature, a wildfire contributing variable, goes down; and b) The Strict case, where the utility's confidence in the wildfire threat forecast model is high, and UAVs are routed based strictly on that forecast. The difference being that in the strict case, the UAV must monitor till the end of the threat period while in the lax case, the UAV can leave the grid before estimated threat end time since, if a wildfire did not occur within about 90% of the threat duration, chances are that it would not occur in that grid. Hence, the UAV saves some time and routes to the next destination.

In these scenarios, the high risk cells were chosen to be [G7, G14, G15, G8, G9, G12], arranged in the order of the forecasted start times (T I) of the wildfire risk, while the UAVs all route from the source grid [G1]. In Table 6.4, the first destination grid is G7 with T G7=3, the earliest time of UAV arrival is at T=2.41<T G7=3, so that the UAV can positioned to monitor before the wildfire risk begins. After the UAV arrival, the time the UAV should remain in the grid for monitoring T G7=3, which means this is the estimated duration of the wildfire threat. The UAV leaves G7 at T=2.41+3=5.41 and checks the grid cells that are reachable from the current G7 given the T I. G8 is the next feasible destination from G7 as by the time the UAV gets to G8, the time would be 5.41+1 (adjacent grids)=6.41, and T G8 is 6.5, hence the UAV can make it in time to its second destination, the UAV then spends τ G8=3 and leaves G8 at 9.41. At that time, the UAV cannot reach any other destination grids in its current trip, making UAV 1 have 2 paths in its trip. Next, UAV 2 picks up from “G1-G14” with earliest arrival time at 3.41 (1.41+1+1) it then spends τ G14=5 and leaves “G14” at 8.41 by which time it cannot make it to any other grids before their T I. Another trip was to “G9,” where the earliest arrival time was 2.41, however, the start time of the wildfire risk was T G9=7, hence, the UAV operator had to start out the UAV on the route on/before T=4.59 and the leave time should be approximately T=9. Same applied to “G12.” In Table 6.5, the illustration is that the model confidence can change the route to the UAVs. For instance, if the forecasting model for T I and τI is closer to 100%, then the sj UAV strictly follows these times and will only leave a grid cell at T=T I+τI. In this case, the sj UAV 1 routes from “G7” to “G12,” instead of “G7” to “G8” as in the previous case, and this would be the best case if there are more UAV supplies that trip time conservation can be overlooked. Runtime for the UAV optimization code was 0.0182 secs.

Furthermore, the UAV optimization also considered the weather in the grids that UAV takes on its trip. One way to include the weather would be to not go through the routes with high wind gusts but in this method, there may be only one efficient route considering the forecast start time, hence the optimal way would be to schedule medium or large UAVs for the trips with high wind gust grids during the times the UAV is flying through. On the same hand, the total trip time would also influence the UAV type (large, medium or small as shown in Table 6.3) which was scheduled for the trip. This parameter can be easily be manually selected by the operator during trip planning given the available UAV types. If the trip is long, e.g., 10 hour-trip, a medium UAV can be scheduled for monitoring since these UAVs can get up to 20 hours of round-trip time. Table 6.3 shows the minimum attributes, as these UAVs can still be improved, for instance, medium UAVs like the Penguin B has an optional 7.5 L capacity fuel tank, and in addition, an 80 W on-board generator system to improve on its flight time from 6 hours to above 20 hours, and does not need a runway as it can take off from a car-top launcher and could be recovered by a large parachute if the need arises.

Therefore, these UAV types can also be used as the initial firefighting efforts. Once a fire is detected, the UAV operator gets an alarm, and depending on the UAV type (and hence payload capacity for carrying firefighting fluids) nearest to the burning grid cell, the operator can use the ground station software to circumvent the early-detected-fire with firefighting fluids, hence bounding the wildfire while routing more firefighting resources to the burning grid cell. The advantage of this method is that the utility does not have to route a ground fire-fighting crew as the first response since road networks are longer and traffic could be a delaying factor. On the same hand, the fluid-carrying UAVs can easily be re-routed to aid contain the fire pending the arrival of the ground crew in order to give the firefighting crew head start.

TABLE 6.4
The UAV Monitoring Tree. The Lax case is proposed such that the service
area can be fully monitored where the SL-PWR UAVs are limited.

| | | | Forecasted | UAV | | UAV |
|---|---|---|---|---|---|---|
| | UAV | Critical | threat | arrival time | UAV monitoring | leave |
| Index | ID | Grid | start time | (earliest) | time estimate | time |
| 1 | 1 | G7 | 3 | 2.41 | 3 | 5.41 |
| 2 | 2 | G14 | 4.5 | 3.41 | 5 | 8.41 |
| 3 | 3 | G15 | 6 | 3.82 | 6 | 9.82 |
| 4 | 1 | G8 | 6.5 | 6.41 | 3 | 9.41 |
| 5 | 4 | G9 | 7 | 2.41 | 2 | ~9 |
| 6 | 5 | G12 | 9 | 3.82 | 1 | ~10 |

| UAV | Feasible | |
|---|---|---|
| ID | Monitoring Paths | Equipment Monitoring Paths |
| 1 | G1 → G2 → G7 | 1) B19 → B20 → B21 → B22 → B10 → B11 → |
| | G1 → G2 → G7 → G8 | B12 → B13 → B14 |
| | | 2) B19 → B20 → B21 → B22 → B10 → B11 → |
| | | B12 → B13 → B14 → B15 → B16 → B17 → B18 |
| 2 | G1 → G6 → G10 → G14 | 1) B4 → B5 → B6 → B7 → B8 → B9 → B26 → |
| | | B27 → B23 → B24 → B25 |
| 3 | G1 → G6 → G10 → G15 | 1) B4 → B5 → B6 → B7 → B8 → B9 → B26 → B27 |
| 4 | G1 → G6 → G9 | 1) B4 → B5 → B6 → B7 → B8 → B9 |
| 5 | G1 → G2 → G7 → G12 | 1) B19 → B20 → B21 → B22 → B10 → B11 → |
| | | B12 → B13 → B14 → B33 |

TABLE 6.5
The UAV Monitoring Tree. The Strict case is proposed where SL-PWR UAV supply is
not limited and the UAV can monitor a grid for the predicted full threat period.

| | | | Forecasted | UAV | | UAV |
|---|---|---|---|---|---|---|
| | UAV | Critical | threat | arrival time | UAV monitoring | leave |
| Index | ID | Grid | start time | (earliest) | time estimate | time |
| 1 | 1 | G7 | 3 | 2.41 | 3 | 6 |
| 2 | 2 | G14 | 4.5 | 3.41 | 5 | 9.5 |
| 3 | 3 | G15 | 6 | 3.82 | 6 | 12 |
| 4 | 1 | G8 | 6.5 | 3.41 | 3 | 9.5 |
| 5 | 4 | G9 | 7 | 2.82 | 2 | 9 |
| 6 | 5 | G12 | 9 | 7.41 | 1 | 10 |

| UAV | Feasible | |
|---|---|---|
| ID | Monitoring Paths | Equipment Monitoring Paths |
| 1 | G1 → G2 → G7 | 1) B19 → B20 → B21 → B22 → B10 → B11 → |
| | G1 → G2 → G7 → G12 | B12 → B13 → B14 |
| | | 2) B19 → B20 → B21 → B22 → B10 → B11 → |
| | | B12 → B13 → B14 → B33 |
| 2 | G1 → G6 → G10 → G14 | 1) B4 → B5 → B6 → B7 → B8 → B9 → B26 → |
| | | B27 → B23 → B24 → B25 |
| 3 | G1 → G6 → G10 → G15 | 1) B4 → B5 → B6 → B7 → B8 → B9 → B26 → B27 |
| 4 | G1 → G2 → G7 → G8 | 1) B19 → B20 → B21 → B22 → B10 → B11 → |
| | | B12 → B13 → B14 → B15 → B16 → B17 → B18 |
| 5 | G1 → G6 → G9 | 1) B4 → B5 → B6 → B7 → B8 → B9 |

The present disclosure provides a self-sufficient low-cost wildfire mitigation (SL-PWR) system and method that is resilience-oriented in its approach to spatiotemporally predict wildfire threat, detect and localize wildfire occurrence, spread, and other wildfire-related incidents e.g., power equipment as ignition sources. The SL-PWR is self-sufficient, because is comprehensive and informs power system resilience at each stage of the resilience trapezoid. The SL-PWR's vegetation module improves vegetation management in the pre-wildfire phase, the power equipment module aids in mitigating endogenous wildfires, the wildfire module aids containment of already progressing wildfires, and the burnt equipment module sees to the restoration of the power grid after wildfire damages. In order to enable these functionalities, the SL-PWR uses already-owned utility UAV resources to obtain input data used in training the SL-PWR modules to comprehensively inform power system resilience against wildfires using spatiotemporally optimized UAV monitoring trees, hence, achieving transparency. Results show effective performance of the SL-PWR in improving power system-wildfire resilience, hence reducing risk. The optimization model developed in SL-PWR for the UAV resources using predicted wildfire threat parameters from STWIP wildfire potential map outputs improves situational awareness with limited availability of UAV resources. This improves resilience by reducing response time, extremely important in wildfire mitigation. Additionally, with this optimization, more monitoring trips can be completed within threat time, encouraging wildfire risk integration with power system operation. Most importantly, the proposed SL-PWR will aid to save lives of utility crew.

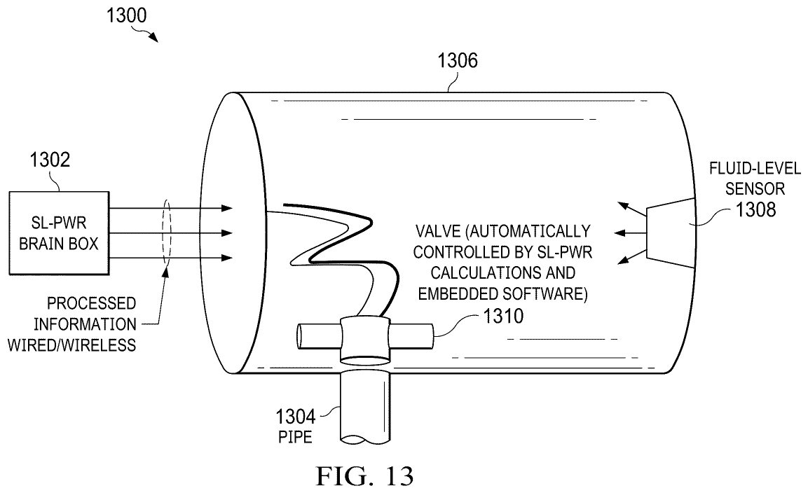

FIG. 13 is a diagram of an of an unmanned aerial vehicle (UAV) 1300 in accordance with an example embodiment of the present disclosure. Sensors, including but not limited to cameras and thermal sensors, are installed on the frame of the SL-PWR brain box 1302 which includes a processor operating under control of embedded software that converts and preprocesses image data and quantitative sensor data into quantitative information for implementing the function of the SL-PWR tool. The fluid tank 1306 includes a fire retardant level sensor 1308 to determine a level of fire retardant remaining in the tank. The fire retardant can be a liquid, such that fire retardant level sensor 1308 is a liquid level sensor. The fire retardant can be a solid, such that fire retardant level sensor 1308 is a weight sensor. Alternatively, a laser system or other suitable systems can be used to illuminate a location for a second vehicle to release fire retardant, such as a guided fire retardant delivery vehicle, a directional fire retardant delivery vehicle on the ground or other suitable vehicles.

The embedded software automates fluid dispersal on the localized fire boundary. Once the wildfire has been localized, the automatic fluid dispersal system works with the height parameter, a, of the UAV 1300, the thermal sensors, retardant level sensors 1308, and the SL-PWR localized wildfire boundary (hf, wf, h, w) defined in equations. 6.26-6.29 herein.

Valve 1310 and pipe 1304 allow the fluid to be let out from the fluid tank 1306. Valve 1310 is placed at ideally to allow or restrain fluid dispersal. Although one valve 1310 is shown, a plurality of valves can also or alternatively be provided. By actuating valve 1310 to open or close, the flow of the firefighting fluid can be turned ON or OFF. The power to valve 1310 is supplied from SL-PWR brain box 1302 or other suitable sources with automated signals from the SL-PWR processor. Valve 1310 can receive wired/wireless messages from SL-PWR brainbox 1302. The fluid is then automatically dispersed and applied on the boundary of the wildfire towards the center for containment.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A method for predictive fire control, comprising:
identifying a plurality of wildfire risk points on a power grid using a processor that is configured to receive power grid data and wildfire data and to transform the power grid data and the wildfire data into wildfire risk point data;
calculating a route for an unmanned aerial vehicle (UAV) to intersect with a maximum number of points as a function of a range of the UAV using the processor that is configured to transform UAV location data and the wildfire risk point data into flight plan data;
controlling the UAV to traverse the route using a second processor;
monitoring one or more sensors for an indication of a wildfire event using the second processor and the UAV; and
controlling the UAV to release a fire retardant using the second processor.

2. The method of claim 1 wherein controlling the UAV to release the fire retardant on the fire using the second processor comprises actuating one or more valves.

3. The method of claim 1 further comprising detecting a fire retardant level at the UAV using a level sensor.

4. The method of claim 1 further comprising:
detecting a fire retardant level at the UAV using a level sensor; and
transmitting the fire retardant level from the UAV to the processor.

5. The method of claim 1 further comprising:
detecting a fire retardant level at the UAV using a sensor;
transmitting the fire retardant level from the UAV to the processor; and
modifying the route as a function of the fire retardant level.

6. The method of claim 1 further comprising:
detecting a fire retardant level at the UAV using a sensor;
transmitting the fire retardant level from the UAV to the processor; and
modifying the release of the fire retardant as a function of the fire retardant level.

7. The method of claim 1 further comprising:
detecting updated wildfire data at the UAV using a sensor; and
transmitting the updated wildfire data from the UAV to the processor.

8. The method of claim 1 further comprising:
detecting updated wildfire data at the UAV using a sensor;
transmitting the updated wildfire data from the UAV to the processor; and
modifying the release of the fire retardant as a function of the updated wildfire data.

9. The method of claim 1 further comprising:
detecting updated wildfire data at the UAV using a sensor;
transmitting the updated wildfire data from the UAV to the processor; and
modifying the route as a function of the updated wildfire data.

10. The method of claim 1 further comprising:
detecting updated wildfire data at the UAV using a sensor;
transmitting the updated wildfire data from the UAV to the processor;
modifying the route as a function of the updated wildfire data; and
modifying the release of the fire retardant as a function of the updated wildfire data and the modified route.

11. A system for predictive fire control, comprising:
a vegetation module operating on a processor and configured to cause the processor to retrieve vegetation data and to perform a spatiotemporal analysis of the vegetation data to generate vegetation risk data;
a power equipment module operating on the processor and configured to cause the processor to retrieve power equipment data and to perform a spatiotemporal analysis of the power equipment data to generate power equipment risk data;
a wildfire module operating on the processor and configured to cause the processor to retrieve wildfire data and to perform a spatiotemporal analysis of the wildfire data to generate wildfire risk data; and
a power system risk assessment system operating on the processor and configured to transform the vegetation risk data, the power equipment risk data and the wildfire risk data into power system risk data.

12. The system of claim 11 further comprising a burnt equipment module operating on the processor and configured to cause the processor to retrieve burnt equipment data and to perform a spatiotemporal analysis of the burnt equipment data to generate burnt equipment risk data, wherein the a power system risk assessment system is further configured to transform the burnt equipment risk data into the power system risk data.

13. The system of claim 11 further comprising an unmanned aerial vehicle (UAV) configured to release a fire retardant on a fire in response to the power system risk data.

14. The system of claim 11 further comprising an unmanned aerial vehicle (UAV) configured to release a fire retardant on a fire in response to the power system risk data by using a second processor to actuate one or more valves.

15. The system of claim 13 further comprising detecting a fire retardant level at the UAV using a level sensor.

16. The system of claim 13 further comprising:
a second processor configured to detect a fire retardant level at the UAV using a level sensor; and
the second processor configured to transmit the fire retardant level from the UAV to the processor.

17. The system of claim 13 further comprising:
a second processor configured to detect a fire retardant level at the UAV using a level sensor;
the second processor configured to transmit the fire retardant level from the UAV to the processor; and
the first processor configured to modify a route as a function of the fire retardant level.

18. The system of claim 13 further comprising:
a second processor configured to detect a fire retardant level at the UAV using a level sensor;
the second processor configured to transmit the fire retardant level from the UAV to the processor; and
the first processor configured to modify the release of the fire retardant as a function of the fire retardant level.

19. The system of claim 13 further comprising:
a sensor of the UAV configured to detect updated wildfire data; and
the second processor configured to transmit the updated wildfire data from the UAV to the processor.

20. The system of claim 13 further comprising:
a sensor configured to detect updated wildfire data at the UAV;
the second processor configured to transmit the updated wildfire data from the UAV to the processor; and
the second processor configured to modify the release of the fire retardant as a function of the updated wildfire data.
